(19) United States
(12) Patent Application Publication
(10) Pub. No.: US 2026/0053603 A1
(43) Pub. Date: Feb. 26, 2026

(54) SYSTEM, METHOD AND APPARATUS FOR PERSONALIZED DENTAL PROSTHESES PLANNING

(71) Applicant: Implant Genius Enterprises Inc., Burnaby (CA)

(72) Inventor: Kevin AMINZADEH, Burnaby (CA)

(21) Appl. No.: 18/868,917

(22) PCT Filed: Jun. 16, 2023
(86) PCT No.: PCT/CA2023/000014

§ 371 Date: Nov. 25, 2024

Related U.S. Application Data
(60) Provisional application No. 63/352,926, filed on Jun. 16, 2022.

(51) Int. Cl. A61C 13/00; A61C 9/00; A61C 13/34

(52) U.S. Cl. CPC A61C 13/0004; A61C 9/0053; A61C 13/0019; A61C 13/34

(57) ABSTRACT

Methods, systems, and techniques for collecting data for use in designing a personalized dental prosthesis for a patient. At least one camera is used to obtain a series of two-dimensional photos or a three-dimensional model of a head and face of the patient. At least one machine learning model is used to determine facial or oral landmarks and a central incisal edge of the prosthesis from the photos or model. Dimensions for the dental prosthesis are determined form the landmarks and central incisal edge. The dimensions include a labial border of the prosthesis, distal borders of the prosthesis, a superior border of the prosthesis, an inferior border of the prosthesis, a lingual border of the prosthesis, and buccal borders of the prosthesis. The dimensions are output to an output file for use in manufacturing the prosthesis.

### CROSS-REFERENCE TO RELATED APPLICATION

The present application claims priority to U.S. provisional patent application No. 63/352,926 , filed on Jun. 16, 2022, and entitled “System, Method and Apparatus for Personalized Dental Prostheses Planning”, the entirety of which is hereby incorporated by reference herein.

### TECHNICAL FIELD

The present disclosure relates generally to methods and systems for standardization of photographic records that may be used to diagnose abnormalities in facial proportions and propose an ideal digital smile design utilizing artificial intelligence, creation of a patient-specific or bespoke bone reduction plane, calculation of ideal dental implant position to minimize deleterious forces on implants and prostheses, and proposing an ideal design for provisional and final prostheses whether on teeth or implants that allows for proper esthetics, phonetics, hygiene, and occlusion.

### BACKGROUND

Many systems and methods have been developed or, more typically, envisioned which, hypothetically, could automate the capture of patient data and diagnosis of missing teeth conditions or non-ideal smiles. These actual (or contemplated) systems employ certain components and subsystems that may automate the capture of patient data (such as CT scan images or intraoral scans), the transfer of such data to a restorative dentist or clinician placing a dental implant, and/or even the interpretation of such data (or, more typically, discrete portions of such data).

However, the currently available methods and systems fail to standardize the received photos for patient head position in three-dimensional space and confirm if the patient has met strict facial pattern requirements for the photos to be diagnostic. For example, the currently available methods and systems do not take into consideration changes in smile patterns due to age, gender, and ethnicity.

In addition, to create a restoration that is durable, cleansable, supports facial tissues, and enables proper speech and mastication, bone reduction may be necessary. Too little bone reduction may result in a prosthetic that fractures, too much bone reduction results in shorter implants placed that may not support the prosthesis in the long-term. Current bone reduction methods do not take into consideration specific patient-based landmarks that are linked to ethnicity and facial growth patterns resulting in higher prosthesis or implant failures and a lost opportunity to restore not only the teeth but also facial harmony.

Attachment of the provisional prosthesis on the day of surgery to implants that have been placed allows the patient to walk in with teeth and leave with teeth and thus reduces patient disability and discomfort while implants are attaching to bone (osseointegration). Current methodologies have clinicians physically grinding the denture or provisional bridge to fit the position of dental implants and then attaching the denture to the implant by bonding or adhesive methods. The grinding of the prosthesis is time-consuming at a time when the patient is at their most vulnerable in the operating room with their gingival tissues flapped open. Waiting for the denture to be ground to the correct proportion and not being able to suture the patient's tissues back into place could cause tissue and bone necrosis and introduce foreign bodies and infection into the open flap. In the traditional “conversion” methodology, the surgical team is waiting for the prosthetic team to attach the prosthesis to the implants and thus OR time is increased and productivity plummets.

There is a general desire for an improved system, method and apparatus for personalized dental prostheses planning that address at least some of the shortcomings of the currently available systems for treatment planning for patients that require a digital smile design and/or patients that require bone reduction and implant placement to replace multiple missing teeth.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be examples and illustrative, not limiting in scope. In various embodiments, one or more of the above-described problems have been reduced or eliminated, while other embodiments are directed to other improvements.

The present disclosure has a number of aspects. These aspects include without limitation:
a method for accurate collection of patient records;
a method for calculating the correct records required to arrive at a diagnosis based on the number and position of teeth that are present in the patient's mouth;
a method for determination of patient's head position by calculation of natural head position by evaluation of landmarks and planes of the face and sending feedback to allow correction of pitch, yaw, roll;
a method for determination of whether a patient is smiling or not based on identification of tooth structures and identification of lip lines;
a method for determination of the highest lip position by calculation of the highest position of the lowest margin of the upper lip;
a method for determination of the lips in their most relaxed position by determination of the lowest position of the upper lip;
a method at arriving at the correct global aesthetic diagnosis by measurement of facial landmarks and planes;
a method for calculation of the incisal edge position in three-dimensional space based on lips at rest and smiling photographs;
a method for determination of patient tooth size based on facial proportions, age, gender, and ethnicity;
a method for determination of the plane of occlusion based on measurement of landmarks and the angles they form within the face and based on gender and ethnicity;
a method for calculation of the amount of bone reduction based on the plane of occlusion, the chosen final prosthesis, and visible prosthesis margin in a smile;
a method for automatic calculation of implant position based on vital structures in the jaw and calculation of inter-implant distances, prosthesis support and force vectors as determined by position of muscles of mastication, position of tooth roots in 3-dimensional space and skeletal growth patterns;
a method for fabrication of a one-piece or two-piece provisional bridge based on scanned position of placed dental implants and/or abutments attached to the implants; and
an apparatus that allows for both scanning of the position of a dental implant and/or abutment in the oral cavity or face and utilization of same scanned apparatus to measure the correct patient bite and attachment apparatus to a specially modified temporary coping.

A first aspect is directed to a new and useful method for diagnosing and identifying a treatment for aesthetic rehabilitation of teeth or replacement of teeth with dental implants.

Another aspect is directed to a new and useful system for diagnosing and identifying a treatment for aesthetic rehabilitation of teeth or replacement of teeth with dental implants. The system comprises a server on which a centralized website is hosted. The server is configured to receive patient data captured through a capturing device such as a smart phone and data received through a website, with such patient data comprising patient photographs, photogrammetric images, LiDAR and video synchronized with the LiDAR to enable 3D facial capture, study models, radiographs, and/or combinations thereof.

Another aspect is directed to a computer program operable within a server to analyze the patient data and identifying at least one diagnosis of the patient's condition (based on the information derived from textbooks and scientific literature, dynamic results derived from ongoing and completed patient treatments, or combinations thereof).

The computer program may allow creation of a digital smile design based on facial measurements, ethnicity, age, and gender. The computer may use a data set of standardized images to make a determination.

The computer program may propose a three-dimensional position for the teeth within the jaw and calculate the amount and angulation of bone reduction required for the ideal prosthesis thickness and shape.

The computer may propose ideal implant types, lengths, diameters and positions to support the prosthesis that would help to minimize harmful forces on the implants while avoiding vital structures such nerves and sinuses.

The computer may propose the ideal multi-unit abutment with a specific angulation and tissue height based upon measurement of soft tissue thickness.

The computer may propose a provisional prosthesis comprising a tooth portion and a pink tissue portion. The prosthesis may be a one-piece or two-piece prosthesis. The teeth portion and the pink portion of the prosthesis may be one piece or may be two pieces of the same or differing material that are cemented or bonded together.

The computer may propose a “scannable bridge” design that rests upon a bone reduction guide or existing implants fixated to the jaw and allows for simultaneous indexing of future prosthesis tooth positions and implants that will support the prosthesis. More particularly, the bridge is a silhouette of the planned 3D prosthesis and is attached to a bone reduction guide or fixated to existing implants within bone to create a stable structure that can be used to scan the position of teeth and register the position of the dental implant, multiunit abutment, and/or temporary coping with respect to these teeth.

According to another aspect, there is provided a method for collecting data for use in designing a personalized dental prosthesis for a patient, the method comprising: obtaining, using at least one camera, a series of two-dimensional photos or a three-dimensional model of a head and face of the patient; using at least one machine learning model to determine facial or oral landmarks and a central incisal edge of the prosthesis from the photos or model; determining dimensions for the dental prosthesis from the landmarks and the central incisal edge, wherein the dimensions comprise a labial border of the prosthesis, distal borders of the prosthesis, a superior border of the prosthesis, an inferior border of the prosthesis, a lingual border of the prosthesis, and buccal borders of the prosthesis; and outputting the dimensions to an output file for use in manufacturing the prosthesis.

The series of two-dimensional photos may be used to determine the dimensions of the dental prosthesis.

The obtaining may comprise obtaining a repose side profile image of the patient, a smiling side profile image of the patient, a smiling frontal image of the patient, and a repose frontal image with mouth open.

The method may further comprise using the at least one machine learning model to confirm the images satisfy photo criteria comprising: the repose side profile image depicts a side profile of a face of the patient in repose with lips closed, and a tragus and an ala of the patient; the smiling side profile image depicts a side profile of the face of the patient in full smile with lips spaced apart and any maxillary and mandibular teeth spaced apart; the smiling frontal image depicts the front of the face of the patient in full smile with lips spaced apart; and the repose frontal image with mouth open depicts a front of the face of the patient in repose with mouth open and maxillary and mandibular teeth not contacting each other.

The obtaining may further comprise obtaining a repose frontal image with mouth closed of the patient and a retracted lips frontal image of the patient.

The method may further comprise using the at least one machine learning model to confirm the images satisfy photo criteria comprising: the repose frontal image with mouth closed depicts a front of the face of the patient in repose with lips closed; and the retracted lips frontal image depicts the front of the face of the patient with lips retracted to display at least one of maxillary or mandibular gingival lines.

The method may further comprise: using the at least one machine learning model to determine that at least one of the photo criteria for at least one of the images is unsatisfied; providing, via a graphical user interface, a graphical indication that the at least one of the images is failing to satisfy the photo criteria for the at least one of the images, wherein the graphical indication is displayed while the patient is taking the at least one of the images that fails to satisfy the photo criteria; and re-obtaining the at least one of the images that fails to satisfy the photo criteria.

The photo criteria may further comprise determining that at least one of a pitch, a yaw, or a roll of a head of the patient are within head orientation limits.

The method may further comprise 3D printing the prosthesis based on the output file.

The prosthesis may be a maxillary prosthesis, the superior border of the prosthesis may comprise a maxillary prosthetic plane, and the inferior border of the prosthesis may comprise a maxillary occlusal plane.

The facial landmarks may comprise the ala and the tragus of the patient, and determining the maxillary occlusal plane may comprise: determining an ala-tragus line of the patient from the repose side profile image; transferring the ala-tragus line to the smiling side profile image; and shifting the ala-tragus line to the incisal edge of the patient, wherein the maxillary occlusal plane is co-planar with the ala-tragus line after the shifting.

The labial border may be determined as a plane from a most inferior portion of most labial gingival tissue of the patient to the incisal edge of the patient.

Determining each of the buccal borders may comprise: determining a maxillary prosthetic plane as a plane that is parallel to and superior to the maxillary occlusal plane; and determining the buccal border as a plane tangential to a buccal gingival tissue surface of the patient through the buccal height of contour of the tooth to the maxillary occlusal plane.

Determining the lingual border may comprise: determining a maxillary prosthetic plane as a plane that is parallel and superior to the maxillary occlusal plane; and determining the lingual border as a surface extending from a height of contour of a lingual side of the maxillary teeth to the maxillary prosthetic plane.

The distal borders may respectively border endmost teeth of the prosthesis and determining each of the distal borders may comprise: determining a maxillary prosthetic plane as a plane that is parallel and superior to the maxillary occlusal plane; and determining the distal border as a plane tangential to a distal height of contour surface of the endmost tooth to the maxillary prosthetic plane.

Determining the maxillary implant platform plane may comprise: determining a maxillary prosthetic plane as a plane that is parallel and superior to the maxillary occlusal plane; determining a maxillary bone ridge line from a cone beam computed tomography image of the patient as a most inferior position of maxillary bone of the patient; determining a maxillary tissue line from an intraoral scan of the patient as a most inferior position of tissue along a maxillary arch of the patient; determining a maxillary calculated tissue thickness as a difference between the maxillary bone ridge line and the maxillary tissue line; determining heights of cylinders extending from the maxillary prosthetic plane; and determining the maxillary implant platform plane as a plane joining a superior aspect of the cylinders.

The method may further comprise determining height and angulation of a multi-unit abutment that connects the maxillary prosthetic plane to a maxillary implant plane superior to the maxillary prosthetic plane, wherein the height and angulation are determined based on the heights of the cylinders and positions of the cylinders in the prosthesis.

The prosthesis may be a mandibular prosthesis, the inferior border of the prosthesis may comprise a mandibular prosthetic plane, and the superior border of the prosthesis may comprise a mandibular occlusal plane.

Determining the mandibular occlusal plane may comprise: determining an ala-tragus plane of the patient from the repose side profile image; determining the mandibular occlusal plane as a plane that is approximately 1 mm superior to a maxillary occlusal plane when maxillary and mandibular teeth are brought together.

The labial border may be determined as a plane from a most inferior portion of most labial gingival tissue of the patient through the tooth height of contour to the level of the incisal edge of the patient.

Determining each of the buccal borders may comprise: determining a mandibular prosthetic plane as a plane that is parallel to and inferior to the mandibular occlusal plane; and determining the buccal border as a plane tangential to a buccal gingival tissue surface of the patient going through the buccal height of contour and stopping at the mandibular prosthetic plane.

Determining the lingual border may comprise: determining a mandibular prosthetic plane as a plane that is parallel to and inferior to the mandibular occlusal plane; and determining the lingual border as a surface extending from a lingual height of contour of the mandibular teeth to the maxillary prosthetic plane.

The distal borders may respectively border endmost teeth of the prosthesis and determining each of the distal borders may comprise: determining a mandibular prosthetic plane as a plane that is parallel to and inferior to the mandibular occlusal plane; and determining the distal border as a plane tangential to a distal height of contour surface of the endmost tooth to the mandibular prosthetic plane.

Determining the mandibular implant platform plane may comprise: determining a mandibular prosthetic plane as a plane that is parallel to and inferior to the mandibular occlusal plane; determining a mandibular bone ridge line from a cone beam computed tomography image of the patient as a most superior position of mandibular bone of the patient; determining a mandibular tissue line from an intraoral scan of the patient as a most superior position of tissue along a mandibular arch of the patient; determining a mandibular calculated tissue thickness as a difference between the mandibular bone ridge line and the mandibular tissue line; determining heights of cylinders extending from the mandibular prosthetic plane; and determining the mandibular implant platform plane as a plane joining an inferior aspect of the cylinders.

The at least one machine learning model may determines the incisal edge of the patient based on one or more factors, wherein the one or more factors comprise factors selected from the group consisting of position of lips of the patient in repose, facial proportions of the patient, patient age, patient gender, and patient ethnicity.

The method may further comprise using the at least one machine learning model to select teeth for the prosthesis from a tooth library based on one or more factors, wherein the one or more factors comprise factors selected from the group consisting of inter-alar distance of the patient, facial width of the patient, width-to-height ratio of teeth, patient gender, and patient ethnicity.

The method may further comprise inserting a scannable bridge structure that is a silhouette of the prosthesis into a mouth of the patient, wherein the bridge structure is attached to a bone reduction guide or fixated to existing implants of the patient.

The method may further comprise using the at least one trained machine learning model to digitally modify the prosthesis to accommodate temporary copings or modify the shape of the prosthesis to conform with the shape of the multi-unit abutment in correct relation to the tooth position and any other multi-unit abutments.

According to another aspect, there is provided a system for collecting data for use in designing a personalized dental prosthesis for a patient, the system comprising: at least one camera; at least one processor communicatively coupled to the at least one camera; and at least one non-transitory computer readable medium communicatively coupled to the at least one processor, the at least one non-transitory computer readable medium having stored thereon computer program code that is executable by the at least one processor and that, when executed by the at least one processor, causes the at least one processor to perform the above-described method.

According to another aspect, there is provided at least one non-transitory computer readable medium having stored thereon computer program code that is executable by at least one processor and that, when executed by the at least one processor, causes the at least one processor to perform the above-described method.

In addition to the example aspects and embodiments described above, further aspects and embodiments will become apparent by reference to the drawings and by study of the following detailed descriptions.

### BRIEF DESCRIPTION OF THE DRAWINGS

Example embodiments are illustrated in referenced figures of the drawings. It is intended that the embodiments and figures disclosed herein are to be considered illustrative rather than restrictive.

FIGS. 1 to 3 show a user interface for implementing a method for personalized dental prostheses planning according to a first embodiment.

FIG. 4 shows anatomical landmarks on hard and soft tissues of the face.

FIG. 5A shows a dental scan image of a patient and FIG. 5B shows a computer generated prostheses planning based on FIG. 5A.

FIG. 6A shows a computer generated tissue replacement image and FIG. 6B shows a computer generated prostheses planning based on FIG. 6A.

FIG. 7 shows a scannable temp coping design.

FIGS. 8A-8F show flowcharts depicting how a computer determines whether images for use in dental prosthesis design satisfy certain photo criteria.

FIGS. 9 and 10 show flowcharts of a method for personalized dental prosthesis planning, according to example embodiments.

FIG. 11 shows a example computer system that may be used as a system for personalized dental prostheses planning, according to an example embodiment.

FIG. 12 shows a frontal photo of a patient with their lips in the highest lip position, according to an example embodiment.

FIGS. 13A-13F show different photos of a patient that are used to determine borders of a personalized dental prosthesis, according to an example embodiment.

FIGS. 14A-14C depict different views of a mandibular scan bridge, according to an example embodiment.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

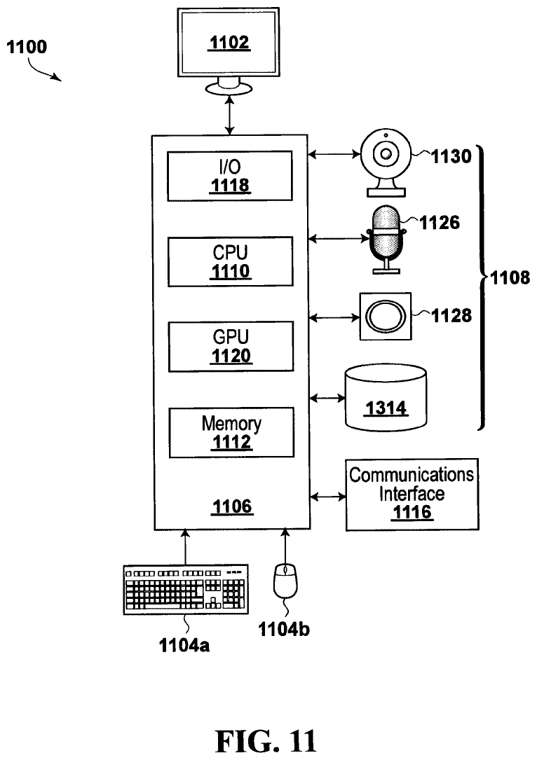

A server is capable of communicating with at least one database (or group of databases). A database may store and/or have access to knowledge and information derived from scientific, medical, textbooks and literature. The database may have access to standardized photos and photogrammetric records that would allow it to compare the newly received photos and/or records with a group of annotated photos in order to arrive at a diagnosis. An example server and database respectively comprise a computer 1106 and storage 1114 as depicted in FIG. 11 and as described further below.

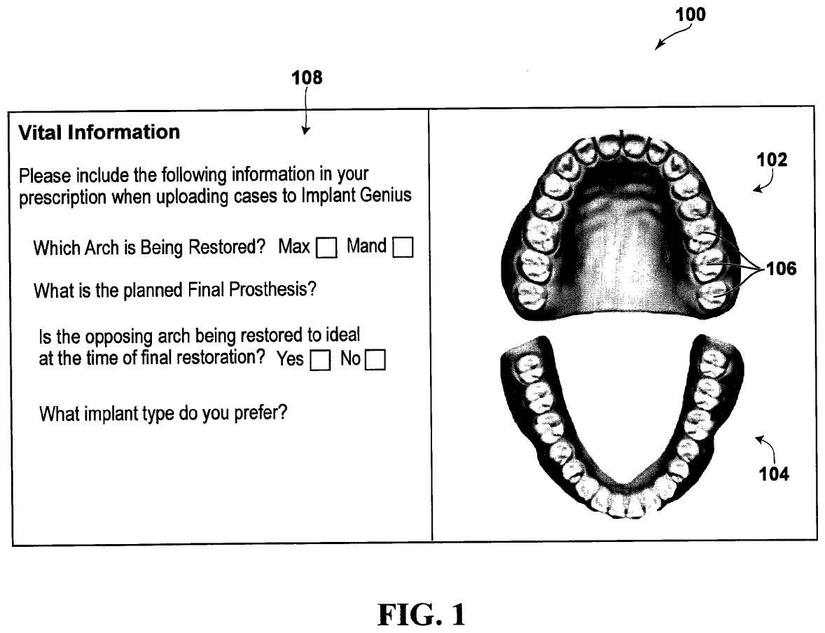

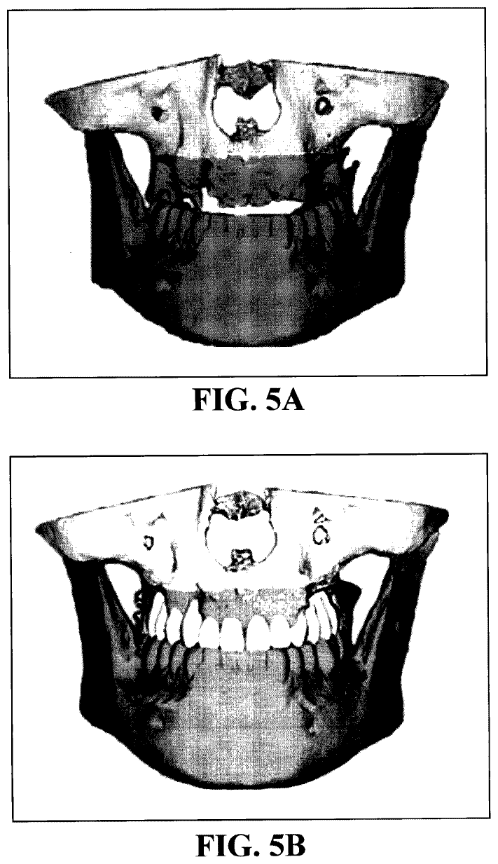

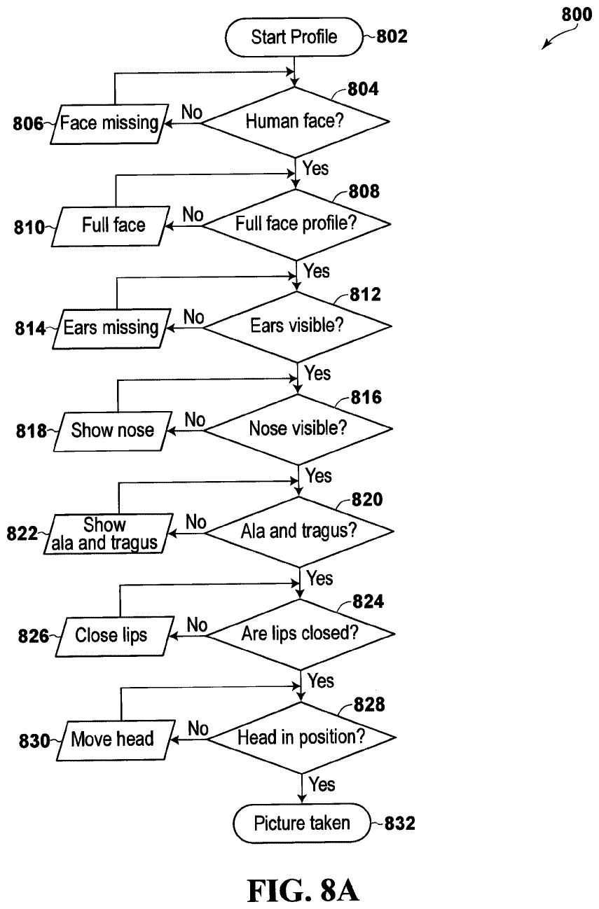

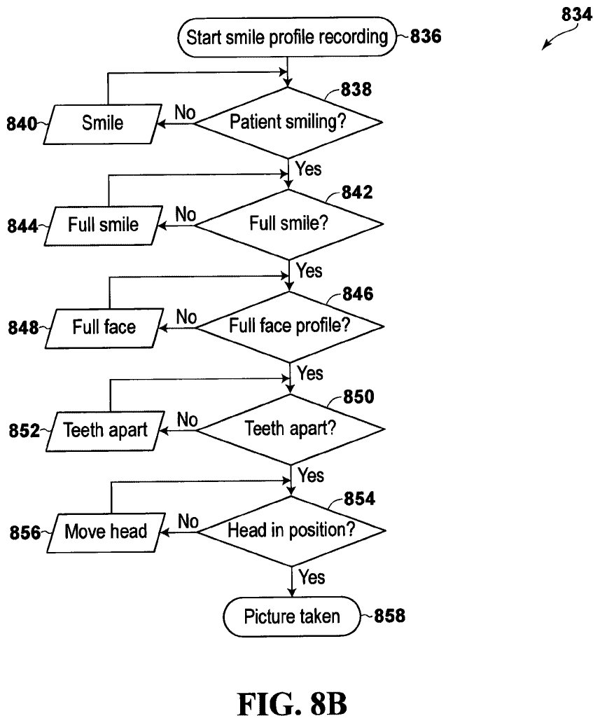

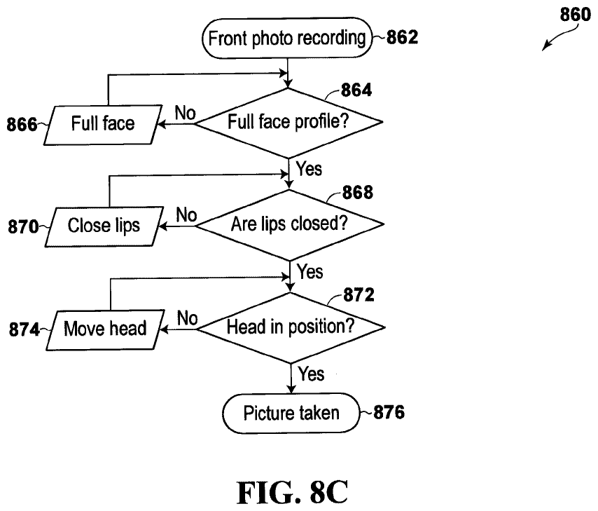

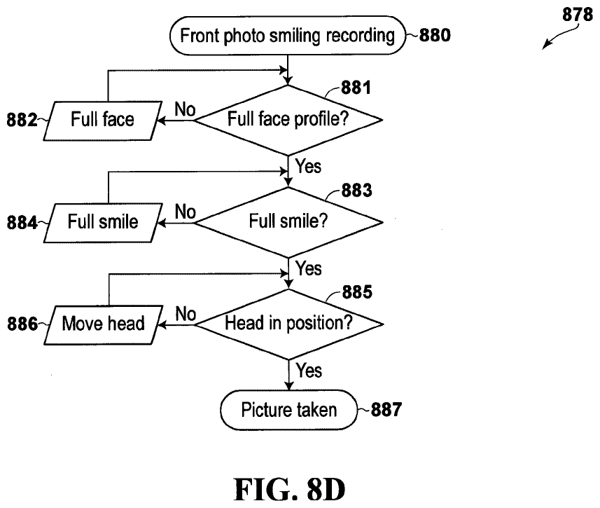

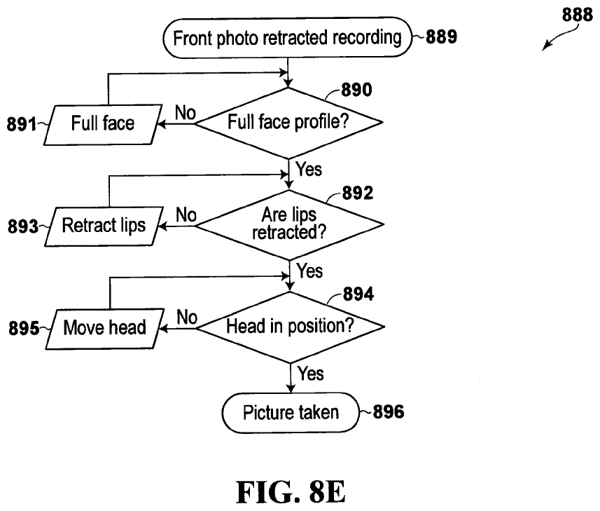

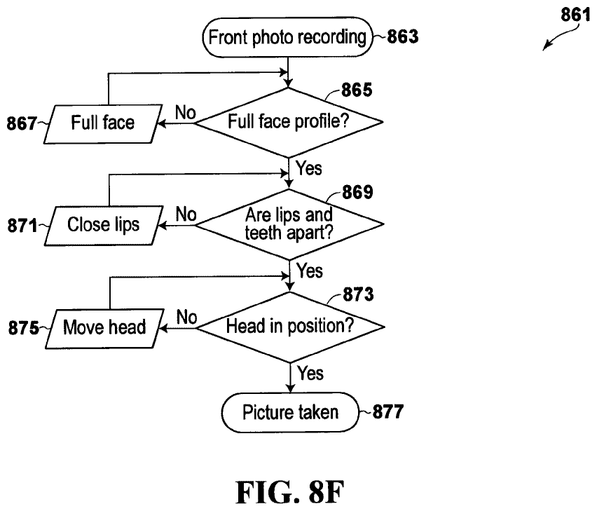

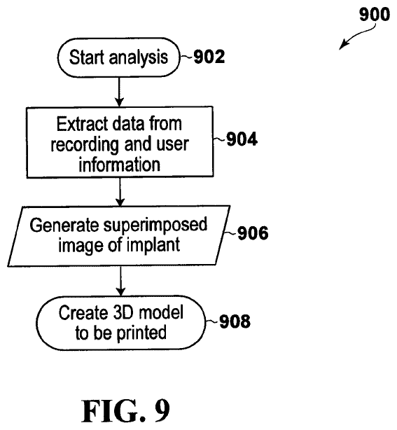

FIG. 9 depicts an example method 900 for personalized dental prosthesis planning using a computer, which is expanded on below. The method 900 begins at block 902, and proceeds to block 904 where it extracts data from a database that stores information in the form of records representing patient photos, such as described in respect of FIGS. 8A to 8F, and patient demographic information, such as is described in respect of FIG. 1, below. At block 906, the computer generates a superimposed image of the prosthesis (such as shown in FIG. 5B, discussed in more detail below) and then outputs a file representing a 3D model at block 908 that may be used to print the prosthesis.

Referring to FIG. 1, according to certain embodiments, the user interface on a mobile application or computer screen will allow the user to select the teeth that are present or missing in the patient's mouth. Based on the number of teeth present or missing, the computer will calculate the records required to perform a comprehensive treatment plan. For example, using the interface, a user can select the teeth that are present or missing, areas where they would like to place a dental implant, and the type of the final prosthesis desired.

More particularly, the user interface 100 depicts example maxillary and mandibular arches 102,104 of a patient. The arches 102,104 depict various teeth 106 that the user may select to indicate which of the selected teeth 106 are absent or present. The user interface 100 also comprises various questions prompting the user to provide patient information 108. Example types of patient information 108 that the user interface 100 prompts the user for include the following:
1. Implant Type to be Placed. The computer uses the patient's preferred implant type to populate the required size and model of the implant automatically. For example, the system's user may be pre-configured with a list of pre-approved implant companies and their corresponding implants. If the user sets the implant company in their profile, then the computer displays available implant models to them become available in a drop-down menu. For example, the computer may be pre-configured to recognize Nobel Biocare™ implants by virtue of the user selecting that implant company in their user profile. In response, the computer may consequently show the user the N1™, Parallel CC™, or Active™ implant models in the drop-down menu, all of which are supplied by Nobel Biocare™.
2. Planned Type of Final Prosthesis. The computer uses the planned final prosthesis type to calculate pre-set minimum size parameters for the prosthesis and the position, size, shape, and contour of the final prosthesis. For example, a zirconia implant bridge type of prosthesis will require a minimum thickness of 10-12 mm to avoid fracture while a removable prosthesis will require a prosthetic space of 15 mm to avoid fracture.
3. Which Arch is to be Restored. This allows the computer to determine which records are to be collected. For example, if the mandibular arch is to be restored, then the computer collects records comprising photos focusing on the mandibular arch, as described further below.
4. Which Teeth are Missing. This allows the computer to determine if a radiographic guide is required. A radiographic guide is a device that stabilizes the patient's jaw before a CT scan is taken. If a radiographic guide is required, the computer determines based on the missing teeth what type and design of radiographic guide is required. For example, a patient who is missing only a few teeth in a jaw will not require a radiographic guide and will be situated in the CT machine with the mouth open. A patient who has six teeth in a dental arch that are well distributed also does not require a radiographic guide and the image must be taken with the mouth open. However, if a patient has only six anterior teeth, they do not have a balanced bite for the purposes of a CT scan and a clear radiographic guide (e.g., in the form of a denture) must be created and two different images must be taken: one image of the radiographic guide by itself and the other image of the patient wearing the radiographic guide with the bite closed.
5. Whether the Opposing Arch is being Restored. If the opposing arch is being restored, the computer designs the opposing bite to a preferably ideal shape and inclination within the human head before designing the prosthesis's smile, bite, and shape. If the opposing arch is not being restored, the computer matches the design of the prosthesis with the patient's extant opposing dentition.
6. Date of Birth. The computer uses date of birth to determine the amount of tooth that is to be displayed with the prosthesis design. For example, studies show that a 22 year old female shows 3-4 mm of maxillary tooth with lips apart and in repose, and a male of the same age shows 2 mm of maxillary teeth. After the age of 40, for every decade of life, 1 mm of upper incisal display at rest is lost. The incisal edge of the lower (mandibular) teeth at rest in at least some embodiments align with the lower lip line to avoid giving patient an “aged” look.
7. Date of Surgery. The computer uses the date of surgery to determine if there is adequate time to fabricate surgical guides and an interim prosthesis. Based on the prosthesis type chosen, the delivery time including shipping time for the final prosthesis may be determined.
8. Ethnicity. The computer uses ethnicity to determine characteristics of facial features and smile-design characteristics such as color and shape of the teeth in the prosthesis. Facial bone structure and soft tissue profile differ with different ethnicities. Tooth size and shape has been shown to be different with patients of different ethnicities. By asking the patient's ethnicity and measuring distance between anatomical landmarks and curvature of the human face, the computer delivers a specific prosthetic smile design based on the library of human dentition categorized through machine learning.
9. Whether the Patient is Wearing a Denture. The computer asks this question to determine whether the denture has a metallic base. If the user indicates the patient is wearing a denture, then the computer asks whether the denture has a metallic base. This allows the computer to recommend duplicating the metal-based denture in a non-metallic material and creating a radiographic guide.

In FIG. 1, the example patient information 108 requested is whether it is the patient's maxillary or mandibular arch that is being restored; what the planned final prosthesis type is; whether the opposing arch is also being restored at the time as the above-selected arch is also being restored; and the patient's preferred implant type. However, any one or more of the above-listed factors, or other factors not listed, may additionally or alternatively be obtained from the user.

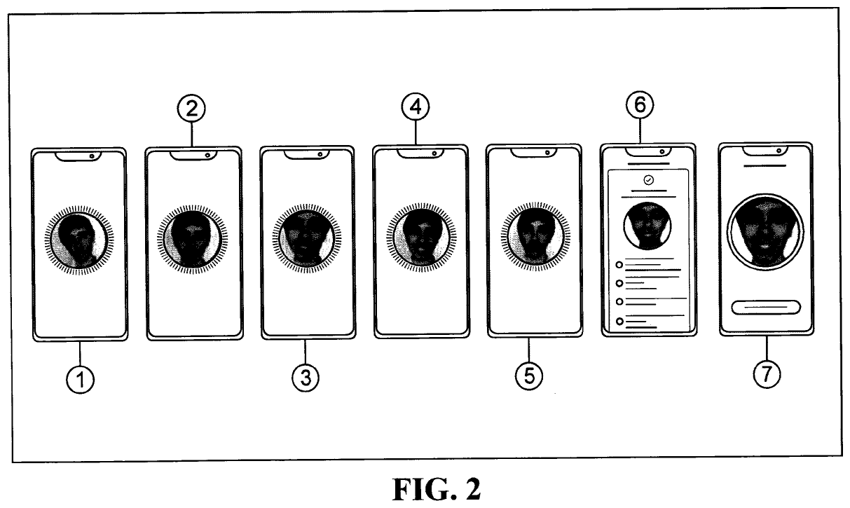

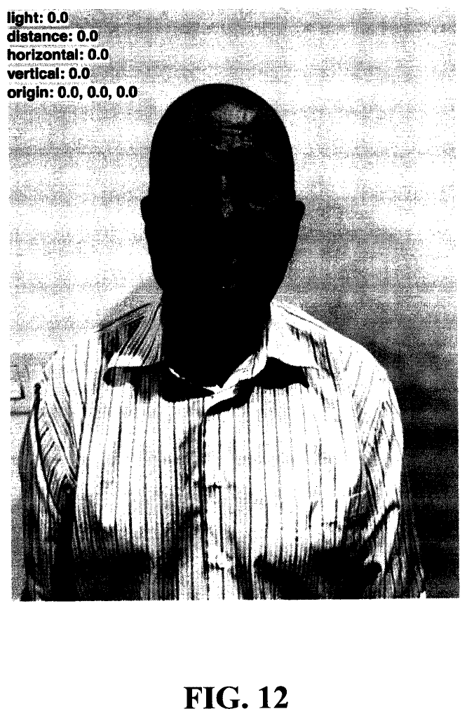

Referring to FIG. 2, according to certain embodiments, each photographic record will have certain requirements that unless the requirements are met, the computer or mobile application will not take the photo and instruct the user to make certain corrections to the patient's face (i.e. pitch, yaw, roll) in order to have the patient's head in an ideal point in three dimensional space. For clarity, a smiling photo of the patient will only be taken when the computer program calculates the correct smiling position. A photo of lips in repose (an “Emma” photo) will calculate the lowest point of the lips at rest while the teeth and lips are slightly apart. In a fully exaggerated smile, the computer calculates the highest position of the upper lips; this may be done based on a corresponding photo of the patient with their lips in their highest position, such as in FIG. 12. In a frontal photo, the computer calculates when lips and teeth are together. In a profile view, the computer calculates if the head is tilted forward or back. In general terms, the computer will calculate head pitch, yaw, roll based on measurement of anatomical landmarks. The computer will arrive at a global facial diagnosis. The computer will design the ideal digital smile design based on facial proportions, ethnicity, age of the patient.

Based on the missing teeth, the program will tell the user what photos to take. The computer will determine if the user head is not in an ideal position known as the “natural head position”, which is a standardized and reproducible position of the head in an upright posture and the eyes focused on a point in the distance at eye level, which implies that the visual axis is horizontal. The computer will prompt the user to correct head position. The computer will automatically take the photo of a head in a correct position. The computer will ensure that facial expressions match the requested photo. The computer program will provide a global diagnosis of the face and present a digital smile design.

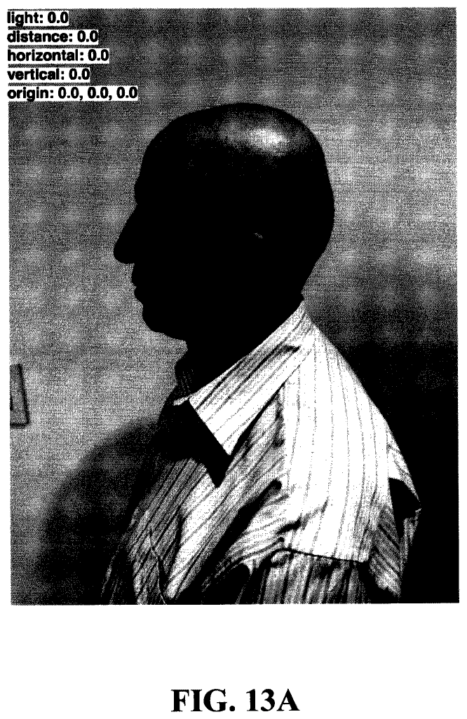

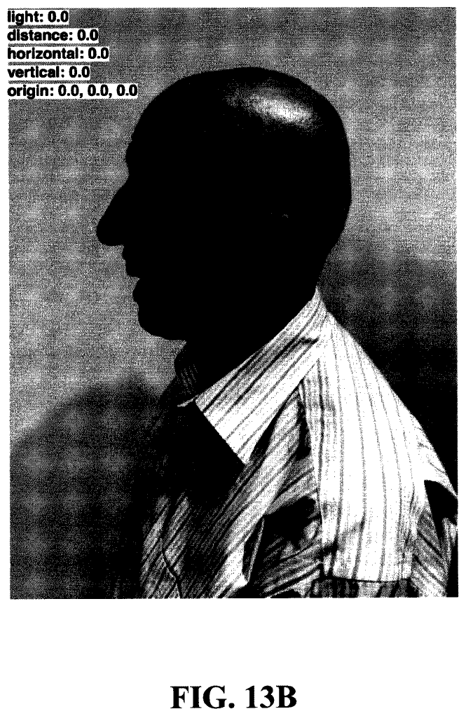

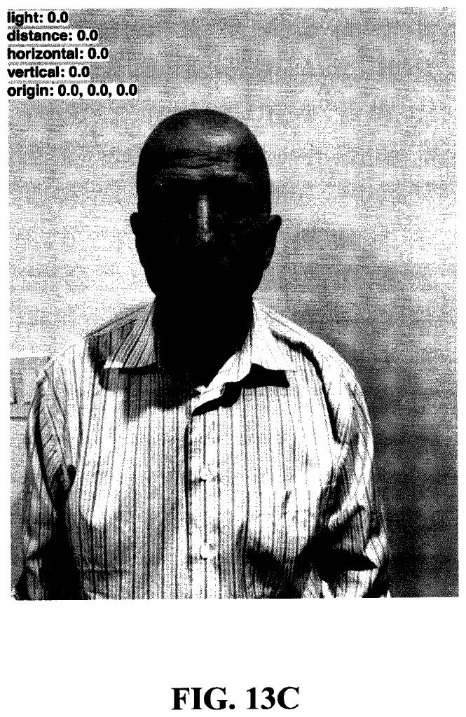

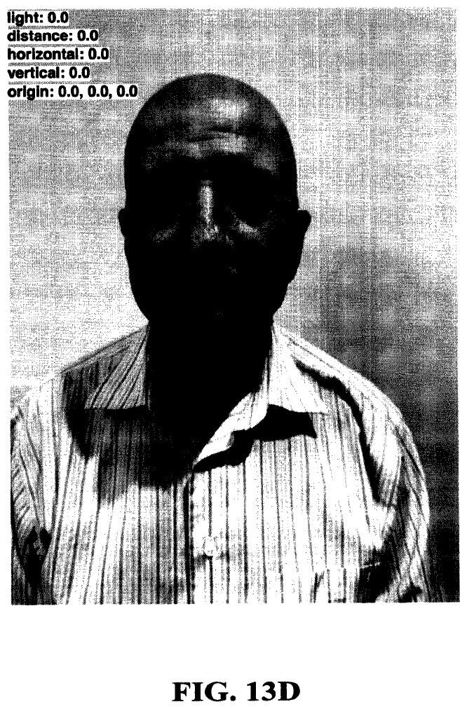

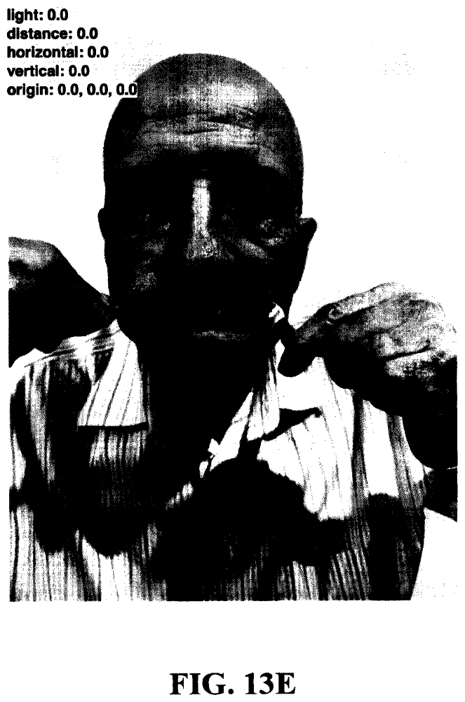

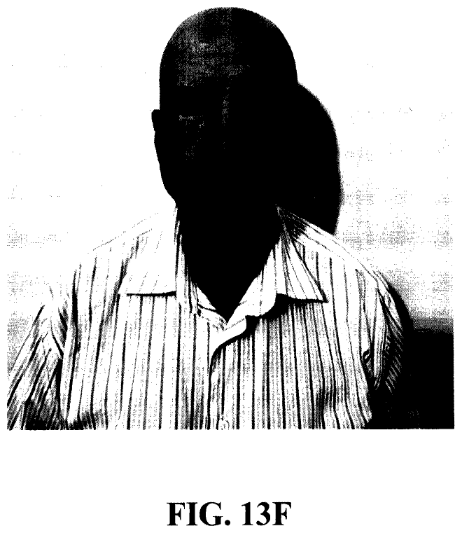

In at least some embodiments, the computer uses one or more cameras attached to it to obtain records comprising the following photos 206:
1. A Repose Side Profile Photo. An example of this photo is shown in FIG. 13A. This is a side profile photo of the patient with their lips and mouth closed. The computer uses this photo to measure the nasolabial angle, HA angle, proportion of the lower ⅓ and mid ⅓ of the face, proportion of maxilla to mandible, and to draw the ala-tragus line of the patient. The computer applies a classifier implemented with at least a first trained machine learning model to recognize that:
   (a) a Human Face Is in the Photo;
   (b) the entire human head is shown in side profile;
   (c) the ear is visible in the photo;
   (d) the nose is visible in the photo;
   (e) the ala of the nose and tragus of the ear can be identified; and
   (f) the lips are together.
The above factors represent example photo criteria for the repose side profile photo. The classifier determines whether any of the photo criteria are unsatisfied and, if any are unsatisfied, provides to the user via the user interface 100 a graphical indication that the photo is failing to satisfy those one or more criteria. The user interface 100 may display this indication while the photo is being taken. For example, as shown in FIG. 2, a circle 202 may encircle the image of the patient, and the circle 202 may change colors and/or other prompts such as textual prompts 204 may be provided to instruct the user how to take a photo that will satisfy the photo criteria. For example, if the patient is smiling, an instruction is given to put the lips together. The computer takes the repose side profile photo when the patient's lips are together. If the head is tilted up or down away from the natural head position, the user interface 100 shows the incorrect position and asks the patient to move their head up or down to arrive at the preferred or ideal position. When this position is reached, the circle 202 around the patient's head is turned green and the repose side profile photo is taken automatically or in response to the user pressing a button.
FIG. 8A depicts a flowchart of a method 800 performed by the computer to capture the repose side profile photo. The method 800 is performed while using a device such as a mobile phone comprising a camera and a display. A live image of the patient is captured by the camera and displayed on the display in real time. The computer provides prompts in the form of the circle 202 and/or textual prompts 204 as described above to ensure that the photo criteria are satisfied before the repose side profile photo is captured based on the live image shown on the display. The landmark identification performed at blocks 804, 808, 812, 816, 820, 824, and 828 below may be performed using at least the first machine learning model. They may be performed with the same model, for example, or multiple models differently trained to identify different anatomical landmarks.
More particularly, the method 800 starts (block 802) and the computer determines whether the image captured by the camera is of a human face (block 804). If not, it displays an appropriate “face missing” prompt to the user (block 806), and waits for a human face to be captured by the camera.
Once the computer captures a human face, it determines whether the patient's full face is shown in profile (block 808). If not, it prompts the user to reposition the camera to provide their full face (block 810) until the patient complies.
Once the computer confirms the image shows the full face in profile, it determines whether the patient's ear is visible (block 812). If not, it prompts the user to reposition the camera to show their ear (block 814) until the patient complies.
Once the computer confirms the image shows the patient's ear, it determines whether the patient's nose is shown in profile (block 816). If not, it prompts the user to reposition the camera to provide their nose (block 818) until the patient complies.
Once the computer confirms the image shows the nose, it determines whether the patient's ala and tragus are depicted (block 820). If not, it prompts the user to reposition the camera to display enough of their nose and ear to identify the ala and target (block 822) until the patient complies.
Once the computer confirms the image shows the patient's ala and tragus, it determines whether the patient's lips are closed (block 824). If not, it prompts the user to close their lips (block 826) until the patient complies.
Once the computer confirms the patient's lips are closed, it determines whether the patient's head is in a suitable orientation such as the natural position (block 828). This may comprise determining whether the pitch, roll, and yaw of the patient's head are within certain orientation limits, as described further below. If not, it prompts the user to reposition their head until it is suitably oriented (block 830) until the patient complies.
Following these operations, the computer concludes the image currently displayed on the display is ready for capture as the repose side profile photo, and takes this picture (block 832).
2. A Smiling Side Profile Photo. An example of this photo is shown in FIG. 13B. This is a side profile photo with the patient smiling fully and the teeth apart. The computer uses this photo to determine the patient's plane of occlusion. Using the classifier, the computer applies the following photo criteria to confirm that:
   (a) the patient is smiling with teeth showing, as opposed to the patient's lips being together;
   (b) the patient is smiling to the full extent of their smile;
   (c) the patient is shown in full side profile, as described above in respect of the repose side profile photo; and
   (d) the teeth are apart.
As described above in respect of the repose side profile photo, if the computer determines that any of the above criteria are unsatisfied, the computer may prompt the user via the user interface 100 to reposition the head and/or to retake the photo.
Human beings who have lost teeth have a tendency to hide their smile due to being ashamed. The computer by applying the classifier and providing suitable feedback via the user interface 100 helps to obtain a satisfactory photo record despite this.
The computer calculates the position of the lip and only take the photo when the upper and lower lips are at their most retracted position with the upper lip in their most superior and lower lips in their most inferior position. The computer only takes the photo when the teeth are sufficiently apart and teeth cusps are identifiable. If the head is tilted up or down away from the natural head position, the user is shown the incorrect position and the patient is asked to move their head up or down to arrive at the most ideal position via indicia such as the circle 202 and textual prompts 204. When this ideal position is reached, the circle 202 around the patient's head is turned green and the photo is taken automatically or by pressing a button.
FIG. 8B depicts a flowchart of a method 834 performed by the computer to capture the smiling side profile photo. Analogous to FIG. 8A, a live image of the patient is captured by the camera and displayed on the display in real time. The computer provides prompts in the form of the circle 202 and/or textual prompts 204 as described above to ensure that the photo criteria are satisfied before the smiling side profile photo is captured based on the live image shown on the display. The landmark identification performed at blocks 838, 842, 846, 850, and 854 below are performed using at least the first machine learning model. They may be performed with the same model, for example, or multiple models differently trained to identify different anatomical landmarks.
More particularly, the method 834 starts (block 836) and the computer determines whether the image captured by the camera is of the patient smiling (block 838). If not, it displays an appropriate “smile” prompt to the user (block 840), and waits for a human face to be captured by the camera.
Once the computer determines the patient is smiling, it determines whether the patient is showing a full smile—e.g., a smile with the corners of the lips in their most superior position (block 842). If not, it prompts the user to smile fully (block 844) until the patient complies.
Once the computer confirms the patient is fulling smiling, it determines whether the patient's full face is shown in profile (block 846). If not, it prompts the user to reposition the camera to provide their full face in profile (block 848) until the patient complies.
Once the computer confirms the image shows the full face in profile, it determines whether the patient's teeth maxillary and mandibular teeth are spaced apart from each other (block 850). If not, it prompts the user to space their arches apart (block 856) until the patient complies.
Once the computer confirms the image shows the patient's maxillary and mandibular teeth spaced apart, it determines whether the patient's head is in a suitable orientation such as the natural position (block 854). This may comprise determining whether the pitch, roll, and yaw of the patient's head are within certain orientation limits, as described further below. If not, it prompts the user to reposition their head until it is suitably oriented (block 856) until the patient complies.
Following these operations, the computer concludes the image currently displayed on the display is ready for capture as the smiling side profile photo, and takes this picture (block 858).
3. A Repose Frontal Photo with Lips Closed. An example of this photo is shown in Fig. 13C. This is a frontal front photo with the patient's lips closed and teeth gently put together. The computer uses this to confirm facial proportions in the side profile photos and to determine facial symmetry. If the head has a roll or pitch or yaw away from the natural head position, the computer recognizes via the classifier and shows the patient how to correct their head position via indicia such as the circle 202 and textual prompts 204 as described above. If the patient's lips are apart, the computer recognizes this via the classifier and similarly prompts the user to close their lips.
FIG. 8C depicts a flowchart of a method 860 performed by the computer to capture the repose frontal photo. Analogous to FIGS. 8A and 8B, a live image of the patient is captured by the camera and displayed on the display in real time. The computer provides prompts in the form of the circle 202 and/or textual prompts 204 as described above to ensure that the photo criteria are satisfied before the repose frontal photo is captured based on the live image shown on the display. The landmark identification performed at blocks 864, 868, and 872 below are performed using at least the first machine learning model. They may be performed with the same model, for example, or multiple models differently trained to identify different anatomical landmarks.
More particularly, the method 860 starts (block 862) and the computer determines whether the image captured by the camera is of the patient's full face (block 864). If not, it requests that the patient reorient the camera or head to display their full face (block 866), and waits for the patient to comply.
Once the patient complies, the computer determines whether the patient's lips are closed (block 868). If not, it prompts the user to close their lips (block 870) until the patient complies.
Once the computer confirms the patient's lips are closed, it determines whether the patient's head is in a suitable orientation such as the natural position (block 872). This may comprise determining whether the pitch, roll, and yaw of the patient's head are within certain orientation limits, as described further below. If not, it prompts the user to reposition their head until it is suitably oriented (block 874) until the patient complies.
Following these operations, the computer concludes the image currently displayed on the display is ready for capture as the repose frontal photo, and takes this picture (block 876).
4. A Smiling Frontal Photo. An example of this photo is shown in FIG. 13D. This is a frontal photo showing the patient in full smile. This photo is used to determine the amount of gingival display and calculate tooth sizes. The computer applies a photo criterion that the upper lip in its highest position before the photo is taken. The computer also applies a photo criterion that if the head has a roll or pitch or yaw away from a predetermined natural head position, the computer recognizes this and shows the patient how to correct their head position via the user interface 100 as described above.
FIG. 8D depicts a flowchart of a method 878 performed by the computer to capture the smiling frontal photo. Analogous to FIGS. 8A to 8C, a live image of the patient is captured by the camera and displayed on the display in real time. The computer provides prompts in the form of the circle 202 and/or textual prompts 204 as described above to ensure that the photo criteria are satisfied before the smiling frontal photo is captured based on the live image shown on the display. The landmark identification performed at blocks 881, 883, and 885 below are performed using at least the first machine learning model. They may be performed with the same model, for example, or multiple models differently trained to identify different anatomical landmarks.
More particularly, the method 878 starts (block 880) and the computer determines whether the image captured by the camera is of the patient's full face (block 881). If not, it requests that the patient reorient the camera or head to display their full face (block 882), and waits for the patient to comply.
Once the computer confirms the patient's full face is shown, it determines whether the patient is showing a full smile—e.g., a smile with the corners of the lips in their most superior position (block 883). If not, it prompts the user to smile fully (block 884) until the patient complies.
Once the computer confirms the patient is smiling fully, it determines whether the patient's head is in a suitable orientation such as the natural position (block 885). This may comprise determining whether the pitch, roll, and yaw of the patient's head are within certain orientation limits, as described further below. If not, it prompts the user to reposition their head until it is suitably oriented (block 886) until the patient complies.
Following these operations, the computer concludes the image currently displayed on the display is ready for capture as the smiling frontal photo, and takes this picture (block 887).
5. A Retracted Lips Frontal Photo. An example of this photo is shown in FIG. 13E. This is a frontal photo with the patient's lips full retracted. This photo is used by the computer will be used to isolate and identify each individual tooth, and the gingival line.
FIG. 8E depicts a flowchart of a method 888 performed by the computer to capture the retracted lips frontal photo. Analogous to FIGS. 8A to 8D, a live image of the patient is captured by the camera and displayed on the display in real time. The computer provides prompts in the form of the circle 202 and/or textual prompts 204 as described above to ensure that the photo criteria are satisfied before the retraced lips frontal photo is captured based on the live image shown on the display. The landmark identification performed at blocks 890, 892, and 894 below are performed using at least the first machine learning model. They may be performed with the same model, for example, or multiple models differently trained to identify different anatomical landmarks.
More particularly, the method 888 starts (block 889) and the computer determines whether the image captured by the camera is of the patient's full face (block 890). If not, it requests that the patient reorient the camera or head to display their full face (block 891), and waits for the patient to comply.
Once the computer confirms the patient's full face is shown, it determines whether the patient's lips are retracted (block 892). If not, it prompts the user to retract their lips (block 893) until the patient complies.
Once the computer confirms the patient's lips are fully retracted, it determines whether the patient's head is in a suitable orientation such as the natural position (block 894). This may comprise determining whether the pitch, roll, and yaw of the patient's head are within certain orientation limits, as described further below. If not, it prompts the user to reposition their head until it is suitably oriented (block 895) until the patient complies.
Following these operations, the computer concludes the image currently displayed on the display is ready for capture as the retracted lips frontal photo, and takes this picture (block 896).
6. A Repose Frontal Photo with Lips Apart. An example of this photo is shown in FIG. 13F. This is a frontal photo with lips at part and at rest, with the mouth slightly open. In contrast to the repose frontal photo described above, the teeth are not touching in this photo. To obtain this photo, the patient is asked to say “Emma”, and the photo is taken as the patient utters the “aa” sound. This photo is used to determine maxillary central incisor tooth display at rest. For example with women in their early twenties, the display at rest is 3-4 mm and for men of the same age it is 2 mm. After the age of forty, for each decade of life, there is a loss of display of 1 mm. Incisal display at rest also depends on ethnicity with African American patients displaying more lip fullness and incisal display at rest.
FIG. 8F depicts a flowchart of a method 861 performed by the computer to capture the repose frontal photo with mouth open and teeth apart. Analogous to FIGS. 8A to 8E, a live image of the patient is captured by the camera and displayed on the display in real time. The computer provides prompts in the form of the circle 202 and/or textual prompts 204 as described above to ensure that the photo criteria are satisfied before the repose frontal photo is captured based on the live image shown on the display. The landmark identification performed at blocks 865, 869, and 873 below are performed using at least the first machine learning model. They may be performed with the same model, for example, or multiple models differently trained to identify different anatomical landmarks.
More particularly, the method 861 starts (block 863) and the computer determines whether the image captured by the camera is of the patient's full face (block 865). If not, it requests that the patient reorient the camera or head to display their full face (block 867), and waits for the patient to comply.
Once the patient complies, the computer determines whether the patient's lips are open with teeth apart (block 869). If not, it prompts the user to close their lips (block 871) until the patient complies.
Once the computer confirms the patient's lips and teeth are apart, it determines whether the patient's head is in a suitable orientation such as the natural position (block 873). This may comprise determining whether the pitch, roll, and yaw of the patient's head are within certain orientation limits, as described further below. If not, it prompts the user to reposition their head until it is suitably oriented (block 875) until the patient complies.
Following these operations, the computer concludes the image currently displayed on the display is ready for capture as the repose frontal photo, and takes this picture (block 877).

While various example photo criteria are provided above, in at least some example embodiments, the minimal photo criteria applied when analyzing each of the photos (or images preceding capturing the photos) are:
1. the repose side profile photo depicts a side profile of a face of the patient in repose with lips closed, and the tragus and the ala of the patient;
2. the smiling side profile photo depicts a side profile of the face of the patient in full smile with lips spaced apart and any maxillary and mandibular teeth spaced apart;
3. the repose frontal photo depicts a front of the face of the patient in repose with lips closed;
4. the smiling frontal photo depicts the front of the face of the patient in full smile with lips spaced apart; and
5. the retracted lips frontal photo depicts the front of the face of the patient with lips retracted to display at least one of maxillary or mandibular gingival lines.
6. The repose frontal photo with lips apart depicts the front of the face of the patients with lips at rest and teeth slightly apart.

Also as described above, the photo criteria for any of the photos (or images preceding the photos) may additionally include confirming that at least one of a pitch, a yaw, or a roll of a head of the patient are within head orientation limits. The head orientation limits correspond to those depicting the patient's head within 5 degrees of center for each of pitch, yaw, and roll, for example.

In at least some other embodiments, while the above photos are being captured or instead of capturing the above photos, LiDAR images may be used to obtain a three-dimensional image of the patient's face with the smile design created in two dimensions or three dimensions. For example, the LiDAR images may be synchronized with a video of the patient's head to arrive at a 3D rendition of the patient's face, and prosthesis design may be based on this 3D rendition; and the smile design may be a two-dimensional smile designed on a two-dimensional photo (i.e., the corrected smile may be superimposed on a photo of the patient) or a three-dimensional smile design used to differentiate the various borders of the prosthesis as described below.

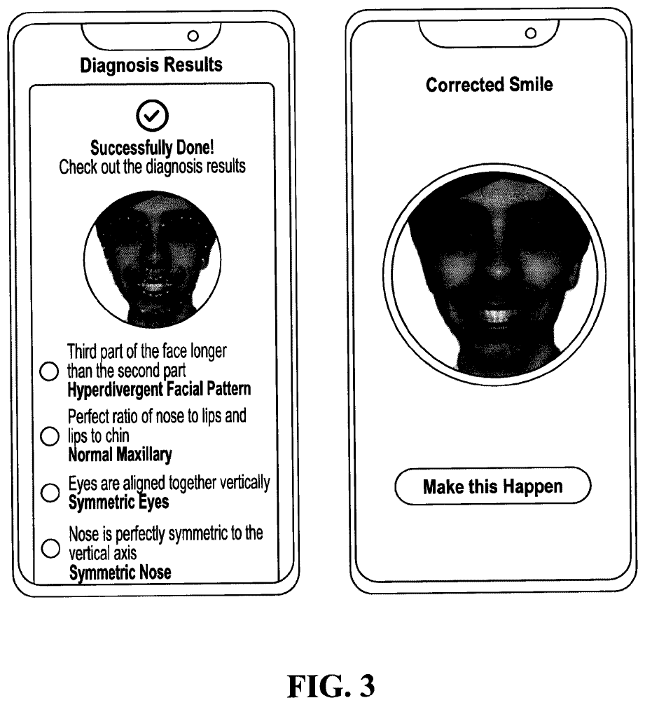

Referring to FIG. 3, according to certain embodiments, the computer program calculates the correct maxillary incisal edge position in 3-dimensional space. The computer also calculates the shape and sizes of the teeth based on the distance between anatomical landmarks in the face. The computer also calculates tooth size based on ethnicity and age. For example, the computer program provides a global diagnosis and creates of patient specific digital smile design based on ideal incisal edge position, age, gender, ethnicity.

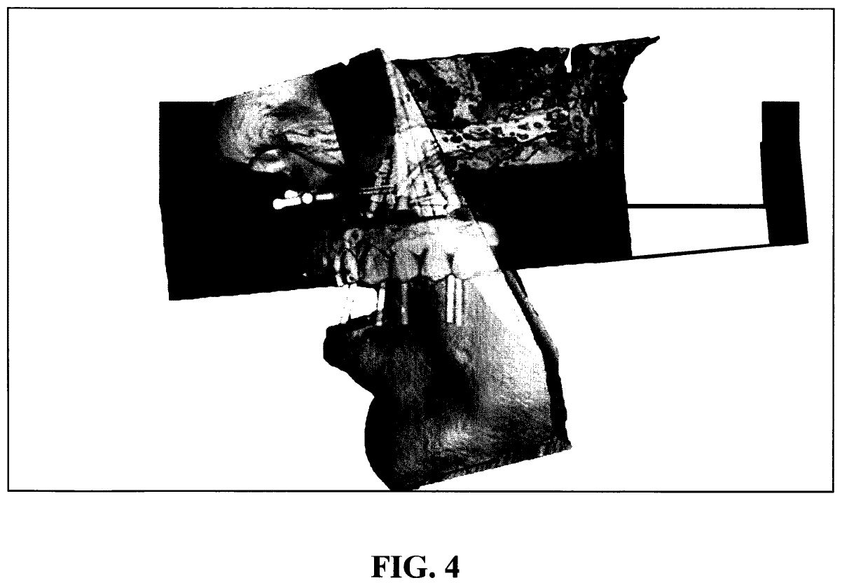

Referring to FIG. 4, according to certain embodiments, the computer program calculates the correct plane of occlusion based on anatomical landmarks of the face. Based on the prosthesis selected, the computer program calculates the thickness of the prosthesis and measures the exact bone reduction amount and plane to allow for a prosthesis that is harmonious with human tissues. The computer program designs the contours of the prosthesis to allow for optimal esthetics, phonetics, and hygiene.

According to certain embodiments, the computer calculates the ideal implant type, position, size to minimize forces on implants and the prosthesis and allow for the least amount of cantilever. The implant positions will also take into consideration nerves and borders of the maxillary sinus.

Referring to FIGS. 5A and 5B, according to certain embodiments, the computer program calculates the amount of “opening of vertical dimension” by separating upper and lower teeth apart from each other by hinging the mandible around a “terminal hinge axis”. The computer calculates the “terminal hinge axis” based on specific anatomical landmarks and calculation of ideal hinge rotation. The landmarks comprise the superior portion of the external auditory meatus, the floor of the nose, and zygomatic processes. FIG. 5A shows opening of the vertical dimension or restoring the vertical dimension by referring to computer calculated ideal dimensions of the face based on age, gender, ethnicity and along a patient specific hinge axis. FIG. 5B shows a computer proposal of the ideal smile based on original photographic and photogrammetric and other records of the patient.

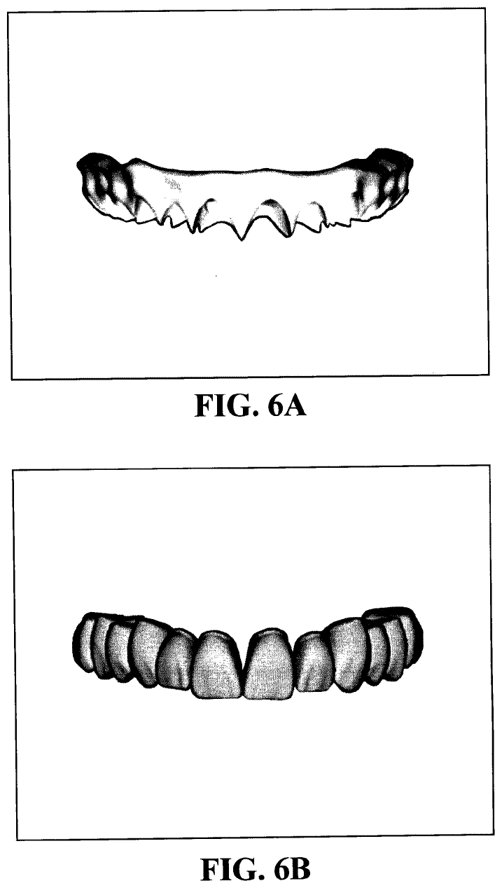

Referring to FIGS. 6A and 6B, according to certain embodiments, the computer program will calculate the shape of the teeth and the shape of the pink tissue portion of the prosthesis and designs them in a way to fit together like a jigsaw puzzle or lock and key. The computer can also design the two pieces as a monolithic structure. The program will allow for exporting of the bridge design in one piece or multiple pieces in. STL format or other 3D printable or milling format.

In particular, the computer may determine the various borders of the prosthesis using at least a second trained machine learning model to determine facial or oral landmarks from the photos described above, and to then use those landmarks in conjunction with intraoral and CT scans (such as cone-beam CT scans [“CBCT scans”]) of the patient to determine the prosthetic borders as described below.

### Maxillary Prosthesis The computer may perform the following when designing the maxillary prosthesis:

1. The computer determines the maxillary incisal edge of the prosthesis using at least the second trained machine learning model by the position of the patient's lips at rest, by the patient's facial proportions, patient age, patient gender, and patient ethnicity. More particularly, the shape of the two upper front teeth are determined by patient age and ethnicity, and by the patient's inter-alar distance. The height of the two upper front teeth is determined based on having a particular width-to-height ratio, such as an ideal 75-80% width-to-height ratio. The position of the lower incisors is calculated by having the lower incisal edge be 1 mm lingual to and 1 mm superior to the maxillary incisal edge when the maxillary and mandibular teeth are in occlusion. width of the lower central incisor teeth are determined by reducing the width of the upper central incisor tooth by 3 mm. The computer modifies the tooth size image in order to arrive at the correct inter-alar distance for the four upper central incisors and have a height that matches the desired width-to-height ratio.
2. The repose side profile photo and the smiling side profile photo are superimposed and the images are matched in size based on immovable landmarks such as the forehead, the glabella, and the bridge of the nose. The ala-tragus line drawn by the computer on the repose side profile photo is transferred to the smiling side profile photo and dropped down to a position such that it intersects the calculated incisal edge line of the prosthesis. This forms the ideal position and tilt of the occlusal line. This occlusal line is compared to the patient's existing occlusal line, which is determined by drawing a line through the existing incisal edge and a line drawn through the average supero-inferior position of the patient's buccal tooth cusps. Teeth above this line are lengthened to meet the line and teeth below the line are shortened to meet the line. In at least some embodiments, the smiling side profile photo with an ideal incisal-occlusal line is transferred as a profile plane and superimposed on the three-dimensional rendering of a CBCT scan image at the mid-facial portion of the CBCT scan so as to match the soft tissue anatomical landmarks of the CBCT scan. The computer then places a plane on the CBCT scan image with the anterior portion of the plane being a line that is drawn from the distal incisal edge of the right upper central incisor to the distal incisal edge of the left upper central incisor and that is parallel to the patient's right and left ala-tragus lines. This plane is the “maxillary occlusal plane”.
In at least some other embodiments, three-dimensional images of the face with cheeks retracted are captured through LiDAR are merged with intraoral scan images and 3D rendering of facial soft tissue on the CT scan. A plane drawn through the right and left ala-tragus on the three-dimensional image and dropped down to the incisal edge of the upper anterior teeth will form the “maxillary occlusal plane”.
3. The computer creates a plane that is parallel to the incisal ala-tragus plane and that is 1 mm superior to the maxillary occlusal plane. This plane, hereinafter referred to as the “maxillary articulating plane”, marks the points on the lingual surfaces of the maxillary anterior teeth and occlusal surfaces of the maxillary posterior teeth where the incisal edges and cusps of lower teeth will contact.
4. Based on the type of prosthesis chosen, the computer creates a plane that is parallel to and superior to the maxillary occlusal plane by a predetermined amount. This plane is the “maxillary prosthetic plane”.
5. The patient's intraoral scan and the CBCT scan are superimposed. The CBCT scan is analyzed and the most inferior position of bone along the maxillary arch is identified to form the “maxillary bone ridge line”. The intraoral scan is analyzed and the most inferior position of the tissue along the maxillary arch is identified as the “maxillary tissue line”. If the patient is dentate, then this line is formed by joining the gingival margins of each tooth at its cementoenamel junction (“CEJ”). The difference between the “maxillary bone ridge line” and “maxillary tissue line” is measured and hereinafter referred to as the “calculated maxillary tissue thickness”.
6. In the anterior maxilla, the computer determines a plane drawn at a tangent to the gingival tissue surface from the highest point in the vestibule to the lowest, most labial point to determine the position and angulation of the gingival tissue as it adheres to the maxillary bone. The maxillary tissue line may or may not coincide with this most labial tissue point. A plane from the most inferior portion of this labial tissue surface to the incisal edge demarcates the labial border of the prosthesis. In the posterior segments, a plane tangential to the gingival tissue surface from the highest point in the vestibule to the maxillary prosthetic plane demarcates the buccal border of the prosthesis.
7. Based on factors such as any one or more of the patient's inter-alar distance, facial width, gender, and ethnicity, the computer selects teeth from a tooth library and sets them upon the occlusal plane with the facial and buccal heights of contour aspects of the teeth sitting against the demarcated labial borders of the prosthesis as outlined in step 6. The teeth arranged on the plane are from the right first molar to the left first molar. By subtracting teeth from this arrangement, the antero-posterior extent of the prosthesis may be shortened. For example, removing a premolar tooth on each side allows the prosthesis to be shortened to match the patient's arch.
8. The computer determines the lingual border of the prosthesis as a plane drawn from the lingual height of contour of the arranged teeth in the dental arch to the tissue line intersected by the maxillary prosthetic plane.
9. The computer determines the distal border of the prosthesis as a plane drawn tangential from the distal height of contour surface of the last tooth extending from the occlusal plane to the maxillary prosthetic plane.
10. The second-most posterior tooth on each side of the maxillary arch and the lateral incisors are chosen as teeth under which dental implants will reside. The computer draws a cylinder of 3 mm diameter from the mid-occlusal point of the second-most posterior tooth to the mid-gingival point of the same tooth to extend to the maxillary prosthetic plane. Based on the calculated tissue thickness under the tooth and the implant chosen, the computer extends the cylinder to be no less than 2.5 mm tall and at most less than 0.5 mm less than the maxillary calculated tissue thickness. This extended cylinder represents the “maxillary abutment height measurement”. The computer draws a cylinder of 3 mm diameter drawn from the cingulum of the lateral incisor and parallel to the mid-facial aspect of the lateral incisor to extend to the maxillary prosthetic plane. Based on the maxillary calculated tissue thickness under the tooth and the implant chosen, the computer extends the cylinder to be no less than 2.5 mm tall and at most is 0.5 mm less than the maxillary calculated tissue thickness. This extended cylinder corresponds to the “maxillary abutment height measurement”.
11. The computer determines a plane joining the superior aspect of the cylinders extending from the maxillary prosthetic plane that denote the maxillary abutment height measurement forms the “maxillary implant platform plane”, which is a superior border of planned prosthesis.
12. The computer determines the thickness of bone that the maxillary implant platform plane intersects by outlining the buccal and palatal bone lines.
13. Based on the measured distance of the thickness of bone at the maxillary implant platform plane and the implant type, which may be user-selected, the computer selects an implant platform size that allows at least 2 mm of bone buccal to the buccal aspect of the maxillary implant platform plane.
14. The computer determines planes that are parallel to the maxillary implant platform plane in 1 mm proportions moving superiorly to end at a plane that joins the anterior and posterior nasal spines.
15. Based on identification of anatomical landmarks by the computer, the anterior wall of the sinus is identified and the most distal two implants are tilted medially with their apex residing within bone that is demarcated by the buccal and lingual bone lines measured in the implant planes. The maxillary implant platform plane and apex form a 30 degree angle against the maxillary prosthetic plane. The computer selects implants of a minimum 10 mm length as a default length. However, any one or more of the width, length, position, and type of implant may be modified by the user.
16. Based on the implant type chosen, an abutment is proposed that satisfies the maxillary abutment height measurement criteria and has a temporary cylinder that would be parallel to the tooth cylinder. The implant is moved within a three-dimensional space and angled to have the tooth cylinder become superimposed upon the abutment temporary coping cylinder.

In at least some example embodiments, parameters such as tooth size, shape, tooth height, and/or borders of the prosthesis can be modified by the user.

Additionally or alternatively, in at least some example embodiments the computer draws a line in the mid-aspect of the prosthetic plane of the prosthesis, with the line being 1 mm superior to the prosthetic plane. The joining of the buccal-gingival and lingual-gingival margins of the prosthesis to the line being 1 mm superior to the prosthetic plane forms an arc having three points. This arc can be manipulated and modified to increase or decrease its pitch. Any portions of the superior border of the prosthesis that may have a concavity thus causing a food trap, is highlighted by the computer (e.g., shown in red) and is either filled in automatically or after intervention from the user.

### Mandibular Prosthesis

The computer determines the mandibular prosthesis's design in a manner analogous to that above for the maxillary prosthesis. In at least some example embodiments, the computer performs the following operations when designing the mandibular prosthesis.
1. The maxillary articulating plane forms the superior border of the mandibular prosthesis, referred to as the “mandibular occlusal plane”.
2. The computer determines the shape of four lower front teeth using any one or more of patient age, patient ethnicity, and the patient's inter-alar distance. The computer determines the width of the lower central incisor teeth by reducing the width of the upper central incisor tooth by 3 mm.
3. Based on the type of prosthesis chosen, the computer determines a plane parallel to and inferior to the mandibular occlusal plane by a measured amount. This plane is the “mandibular prosthetic plane”. The “measured amount” may be, for example, 10-12 mm for a Zirconia prosthesis; 15 mm for a metal-resin prosthesis; and 16 mm for a removable overdenture.
4. The intraoral scan and the CBCT scan are superimposed. The computer analyzes the CBCT scan and the most superior position of bone along the mandibular arch is identified as the “mandibular bone ridge line”. The computer analyzes the intraoral scan and the most superior position of the tissue along the mandibular arch is identified as the “mandibular tissue line”. If the patient is dentate, then this line is formed by joining the gingival margins of each tooth at its CEJ. The difference between the “mandibular bone ridge line” and “mandibular tissue line” is measured and referred to as the “calculated mandibular tissue thickness”.
5. In the anterior mandible, the computer determines a plane tangent to the gingival tissue surface from the lowest point in the vestibule to the highest, most labial point. This plane is used to determine the position and angulation of the gingival tissue as it adheres to the mandibular bone. The “calculated mandibular tissue line” may or may not coincide with this most labial tissue point. The computer determines the labial border of the prosthesis as a plane drawn from the most inferior portion of this labial tissue surface to the incisal edge. In the posterior segments, the computer determines the buccal border as a plane tangential to the gingival tissue surface from the lowest point in the vestibule tangent to the buccal heights of contour and ending at the mandibular prosthetic plane.
6. Based on any one or more of maxillary central incisor tooth measurements, patient facial width, patient gender, and patient ethnicity, the computer selects mandibular teeth from the tooth library and sets them upon the occlusal plane with the labial and buccal heights of contour of the teeth sitting against the demarcated labial and buccal borders of the prosthesis. For further clarity, the teeth arranged on the occlusal plane are from the right first molar to the left first molar. By subtracting teeth from this arrangement, the antero-posterior extent of the prosthesis may be shortened. For example, removing a premolar tooth on each side allow the prosthesis to be shortened to match the patient's arch.
7. The computer determines the lingual border of the prosthesis as a plane drawn from the lingual height of contour of the arranged teeth in the dental arch to the tissue line intersected by the mandibular prosthetic plane.
8. The computer determines the distal border of the prosthesis as a line drawn tangential from the distal height of contour surface of the last tooth extending from the mandibular occlusal plane to the mandibular prosthetic plane.
9. The second-most posterior tooth on each side and the lateral incisors are chosen as teeth under which the dental implants are to reside. The computer draws a cylinder of 3 mm diameter from the mid-occlusal point of the second-most posterior tooth to the mid-gingival point of the same tooth to the mandibular prosthetic plane. Based on the calculated mandibular tissue thickness under the tooth and the type of implant chosen, the cylinder is extended such that it is no less than 2.5 mm tall and at most is 0.5 mm less than the calculated mandibular tissue thickness. This extended cylinder is the “abutment height measurement”. The computer draws a cylinder of 3 mm from the cingulum of the lateral incisor that is parallel to the mid-facial aspect of the lateral incisor to the mandibular prosthetic plane. Based on the mandibular calculated tissue thickness under the tooth and the implant chosen, the cylinder is extended that is no less than 2.5 mm tall and at most is less than 0.5 mm less than the mandibular calculated tissue thickness. This extended cylinder forms the “mandibular abutment height measurement”.
10. The computer determines a plane joining the inferior aspect of the cylinders extending from the mandibular prosthetic plane to form the “mandibular implant platform plane”.
11. The computer determines the thickness of bone that the mandibular implant platform plane intersects by outlining the buccal and lingual bone lines.
12. Based on the measured distance of the thickness of bone at the mandibular implant platform plane and the user's indicated preferred implant, an implant platform size is chosen that allows at least 2 mm of bone buccal to the buccal aspect of the mandibular implant platform plane.
13. The computer draws a series of planes that are parallel to the mandibular implant platform plane, with each subsequent plane being 1 mm inferior to the immediately preceding plane, and the final plane being one plane through the inferior border of the mandible. This series of planes are the “implant planes”.
14. The computer identifies the opening of the mental foramina. The computer determines a frontal plane that is 2 mm anterior to each mental foramina and demarcates the distal extension of the distal implant on the mandibular implant platform plane. The apex of the most distal two implants is tilted medially with their apex residing within bone that is demarcated by the buccal and lingual bone lines measured in the implant planes for each of the most distal teeth. The implant platform and apex form a 30 degree angle against the mandibular prosthetic plane. The computer by default selects implants of a minimum 10 mm length as a standard length; however, the width, length, position, and/or type of implant may be modified by the user.
15. Based on the implant company and implant type chosen, the computer proposes an abutment that satisfies the mandibular abutment height measurement and has a temporary abutment cylinder parallel to the tooth cylinder. The computer moves the implant within a three dimensional space and angles it in such a way to have the tooth cylinder become superimposed upon the abutment temporary coping cylinder.
16. Prosthesis parameters such as tooth size, shape, tooth height, and/or borders of the prosthesis determined by the computer above may also be manually modified by the user.

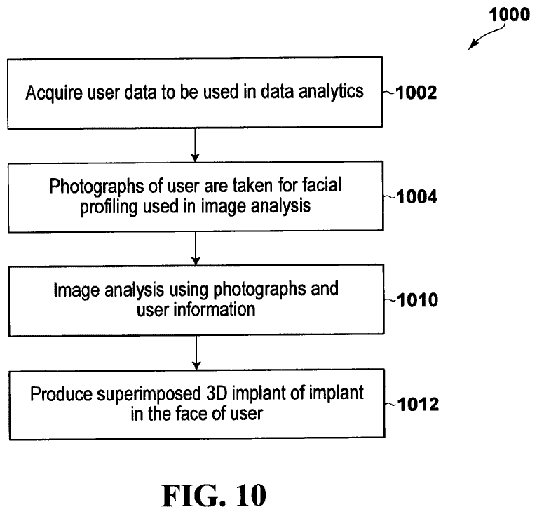

FIG. 10 depicts another example method 1000 for personalized dental prosthesis planning that is computer performed. At block 1002, the computer acquires the patient data to be used in the subsequently performed data analytics; for example, the patient information 108 discussed in respect of FIG. 1 is example user data. At block 1004, the computer obtains the various photos of the patient described above in respect of FIGS. 8A to 8F. Those images are analyzed by the computer at block 1006 as described in respect of FIGS. 8A to 8F; and, together with the patient information 108 and any other data collected at block 1002, the computer determines the various borders that delineate the planned prosthesis and the teeth. Once those borders are delineated, the computer may produce a 3D model of the prosthesis and superimpose it on the patient's face for quality assurance or adjustment purposes. The prosthesis is subsequently manufactured at block 1010, such as by 3D printing, by relying on a .STL or other design file corresponding to the prosthesis's borders and the teeth selected for it.

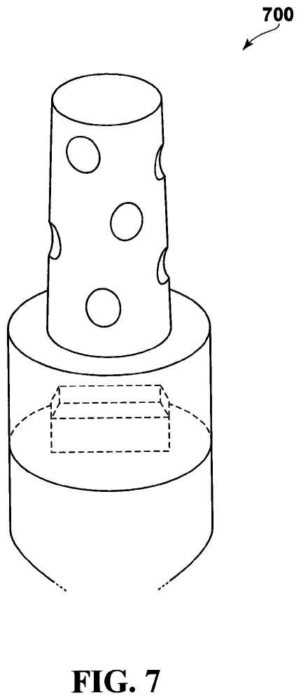

Referring to FIG. 7, according to certain embodiments, a temporary coping design that allows for placement on an abutment or attach directly to the implant and allow for scanning of the temporary coping and incorporating its design into the provisional bridge. FIG. 7 shows a scannable temp coping design to allow for intraoral scanning and attachment to the provisional bridge. Note the dimples will act as matching surfaces and for retention. The zone through tissues will be gold anodized.

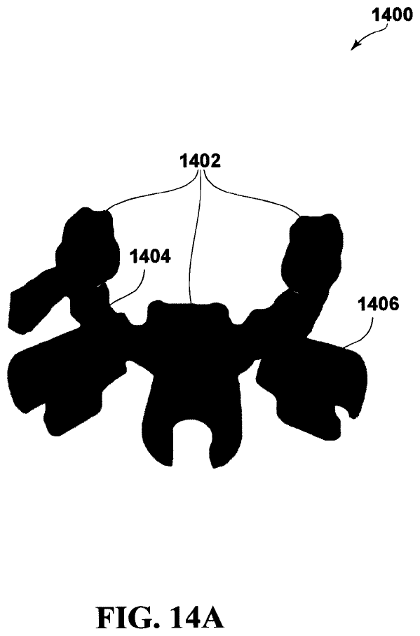

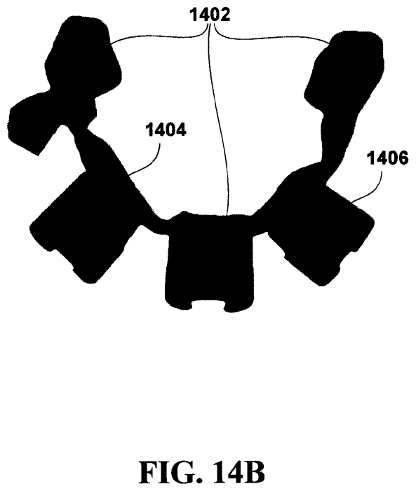

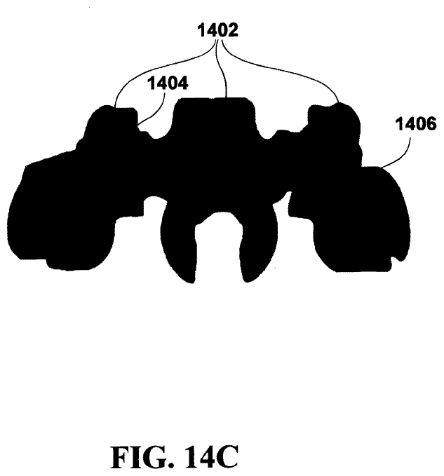

FIGS. 14A-14C respectively depict front perspective, superior, and frontal views of an example scan bridge 1400, illustrative of the bridge described above. The bridge 1400 comprises three occlusion points 1402, allowing for tripodization of occlusion. The bridge 1400 also comprises one or more windows 1404, allowing for ease of scanning of a temporary coping or scan body. One or more indexing grooves 1406 also comprise part of the bridge 1400, with the indexing grooves 1406 sitting on a bone reduction guide or implant, fixated directly to the bone, or otherwise affixed relative to the bone. The bridge 1400 may be scalloped or flat for scanning accuracy or to register the patient's gingival line.

The disclosure provides that trained artificial intelligence models will preferably be employed in order to create an artificial neural network, which will enable the server to perform a global facial diagnosis, treatment planning and prognostication steps described herein. More particularly, an example of the one or more machine learning models referred to above are described in further detail below.

As described above, 2D or 3D images may be used for dental prosthesis planning. For 2D images, a series of pictures are taken from various orientations of the patient's head, with the specific details of these orientations provided in advance as described above. These 2D images serve as the foundation for subsequent analysis and processing.

To obtain a comprehensive representation of the patient's craniofacial structure, multiple images are captured from different directions and combined to create a 3D mesh or point cloud. Techniques such as Structure from Motion (SfM) are employed to generate the 3D scans. Additionally, a combination of a ranging device (e.g., LiDAR sensors, stereo cameras, ultrasound) and an imaging system (e.g., photo or video) can be utilized. The ranging sensor captures the 3D point cloud or mesh, while photos and videos provide color information to create a complete model.

In at least some embodiments, the computer detects facial landmarks on both 2D images and 3D models of the face/head. Landmark detection on the face is achieved using approaches such as Local Binary Features, Active Appearance Model, Histogram Oriented Methods, or ensemble models of regression trees. These pre-annotated facial landmark datasets are used for training purposes.

For 3D models, a two-step approach is employed. First, 2D snapshots are captured from different orientations, and 2D models are used to detect landmarks. Then, by combining and analyzing the detection results from different orientations, the optimal locations of the landmarks are determined. The position estimations of the landmarks are refined by comparing the expected and measured values using techniques such as Kalman filtering.

Proportions of facial features are validated using the detected landmarks. The relative location and orientation of the landmarks are utilized to detect facial expressions, ensuring that the images are captured in the correct orientation and that all required facial expressions and mouth conditions are recorded. The smile designs and dental implant models generated in at least some embodiments are constructed in proportion to the patient's facial features.

The at least one machine learning model used in in at least some embodiments incorporates a generative model capable of creating 2D or 3D images/models of the teeth. The at least one machine learning model considers the desired proportion between facial features, gums, and/or teeth in the loss function. Additionally, the model is provided with multiple noisy and low-resolution copies of the user's image or 3D model to establish the context for generating the desired output.

One example machine learning model is one that has a Generative Adversarial Network (GAN) architecture. The GAN comprises a discriminator convolutional neural network model, which classifies whether an image is real or generated, and a generator model that utilizes inverse convolutional layers to transform an input into a complete 2D image or 3D point cloud.

For example, the discriminator model can include two 2D/3D convolutional layers with a specified number of filters, such as 64 filters each, a suitable kernel size (e.g., 3), and an appropriate stride size (e.g., greater than 2). The output layer of the discriminator model has a single node with a sigmoid activation function to predict whether the input sample is real or fake, and the model is trained to minimize a binary loss function.

Various configurations, such as different numbers of layers, kernel sizes, and activation functions, can be employed to optimize the discriminator model's performance. Other types of networks, such as LSTM, CONVLSTM, and autoencoders, can also be considered to achieve optimal discrimination capabilities. The structure of the network, including filter type, size, stride length, etc., are determined for example through hyperparameter tuning.

The loss function for the 2D smile design aims to detect whether the generated image is real or fake. It utilizes a knowledge distillation algorithm to capture landmarks on the generated image and incorporates the size and proportions of the generated teeth with respect to the face as measures to identify real and fake images. This approach encourages the generative model to produce 2D images or 3D models with the desired proportions.

Similarly, the loss function for the 3D model aims to detect the authenticity of the generated model. It utilizes an algorithm [2] to capture landmarks on the generated model and considers the size and proportions of the generated teeth with respect to each other. Disproportionate models are penalized as fake images. This encourages the generative model to generate 2D images or 3D models with the desired proportions.

The generator model is responsible for creating plausible 2D images or 3D models of the teeth. It takes a point from a latent space as input and outputs the 2D/3D image/model. For example, the latent space may be a vector space populated with pixel values of the user's image, where the mouth area is replaced with random/zero values or multiple copies of the user's image with or without added noise. In the case of 3D model design, the latent space may hold values from a 3D scan of the face, such as a vector with 10,000 dimensions.

The architecture of the generator model comprises layers that sequentially construct the image/3D model from the latent space. For example, sequential upsampling and convolution filters may be utilized, or alternative approaches like diffusion models may be employed.

The weights in the generator model are updated based on the performance of the discriminator model. In one training approach, the discriminator model is separately trained on samples of real and generated data. Once the parameters of the discriminator model are frozen, the generator and discriminator models are combined. The generator model's parameters are updated using the output of the discriminator model's loss function through backpropagation. Generated samples identified as fake by the discriminator model result in a higher loss value, leading to more significant updates to the generator model's parameters (training).

In at least some embodiments, the optimal location for placing the 2D smile design and the generated 2D/3D dental implant models is determined. The positioning of the dental model on 2D and 3D data is based on features extracted from facial landmarks, such as the orientation of the line connecting the ala of the nose and the upper border of the tragus bilaterally, the visibility level of teeth in the repose frontal image with mouth open, and both frontal and side profile smile facial expressions, and the intercanine distance in proportion to the interalar width. These features aid in accurately placing the smile design and dental implant models, ensuring a natural and harmonious result.

The at least one machine learning model is provided with an optimisation function as weighted sum of the misalignment's errors measured by these features and optimal alignment is achieve by minimising the optimisation function. Different stochastic and deterministic solvers are used to find the optimal solution (e.g. simulated annealing).

An example computer system in respect of which the method for prosthesis design and manufacture described above may be implemented is presented as a block diagram in FIG. 11. The example computer system is denoted generally by reference numeral 1100 and includes a display 1102, input devices in the form of keyboard 1104a and pointing device 1104b, computer 1106 and external devices 1108. One such example device is a 3D printer, which may be used to print the prosthesis based on the STL file or another 3D or millable file format. While pointing device 1104b is depicted as a mouse, it will be appreciated that other types of pointing device, or a touch screen, may also be used.

The computer 1106 may contain one or more processors or microprocessors, such as a central processing unit (CPU) 1110. The CPU 1110 performs arithmetic calculations and control functions to execute software stored in a non-transitory internal memory 1112, preferably random access memory (RAM) and/or read only memory (ROM), and possibly storage 1114. The storage 1114 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This storage 1114 may be physically internal to the computer 1106, or external as shown in FIG. 11, or both.

The one or more processors or microprocessors may comprise any suitable processing unit such as an artificial intelligence accelerator, programmable logic controller, a microcontroller (which comprises both a processing unit and a non-transitory computer readable medium), Al accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal memory 1112 and/or storage 1114 for execution by the one or more processors or microprocessors to effect neural network pre-training, training, or use of a trained network for inference.

The computer system 1100 may also include other similar means for allowing computer programs or other instructions to be loaded. Such means can include, for example, a communications interface 1116 which allows software and data to be transferred between the computer system 1100 and external systems and networks. Examples of communications interface 1116 can include a modem, a network interface such as an Ethernet card, a wireless communication interface, or a serial or parallel communications port. Software and data transferred via communications interface 1116 are in the form of signals which can be electronic, acoustic, electromagnetic, optical or other signals capable of being received by communications interface 1116. Multiple interfaces, of course, can be provided on a single computer system 1100.

Input and output to and from the computer 1106 is administered by the input/output (I/O) interface 1118. This I/O interface 1118 administers control of the display 1102, keyboard 1104a, external devices 1108 and other such components of the computer system 1100. The computer 1106 also includes a graphical processing unit (GPU) 1120. The latter may also be used for computational purposes as an adjunct to, or instead of, the CPU 1110, for mathematical calculations.

The external devices 1108 include a microphone 1126, a speaker 1128 and a camera 1130. Although shown as external devices, they may alternatively be built in as part of the hardware of the computer system 1100. For example, the camera 1130 may be used to obtain the various photos described above in respect of FIGS. 8A to 8F.

The various components of the computer system 1100 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C”means “any one or more of A, B, and C”.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for collecting data for use in designing a personalized dental prosthesis for a patient, the method comprising:
(a) obtaining, using at least one camera, a series of two-dimensional photos or a three-dimensional model of a head and face of the patient;
(b) using at least one machine learning model to determine facial or oral landmarks and a central incisal edge of the prosthesis from the photos or model;
(c) determining dimensions for the dental prosthesis from the landmarks and the central incisal edge, wherein the dimensions comprise a labial border of the prosthesis, distal borders of the prosthesis, a superior border of the prosthesis, an inferior border of the prosthesis, a lingual border of the prosthesis, and buccal borders of the prosthesis; and
(d) outputting the dimensions to an output file for use in manufacturing the prosthesis.

2. The method of claim 1, wherein the series of two-dimensional photos are used to determine the dimensions of the dental prosthesis.

3. The method of claim 2, wherein the obtaining comprises obtaining a repose side profile image of the patient, a smiling side profile image of the patient, a smiling frontal image of the patient, and a repose frontal image with mouth open.

4. The method of claim 3, further comprising using the at least one machine learning model to confirm the images satisfy photo criteria comprising:
(a) the repose side profile image depicts a side profile of a face of the patient in repose with lips closed, and a tragus and an ala of the patient;
(b) the smiling side profile image depicts a side profile of the face of the patient in full smile with lips spaced apart and any maxillary and mandibular teeth spaced apart;
(c) the smiling frontal image depicts the front of the face of the patient in full smile with lips spaced apart; and
(d) the repose frontal image with mouth open depicts a front of the face of the patient in repose with mouth open and maxillary and mandibular teeth not contacting each other.

5. The method of claim 4, wherein the obtaining further comprises obtaining a repose frontal image with mouth closed of the patient and a retracted lips frontal image of the patient.

6. The method of claim 5, further comprising using the at least one machine learning model to confirm the images satisfy photo criteria comprising:
(a) the repose frontal image with mouth closed depicts a front of the face of the patient in repose with lips closed; and
(b) the retracted lips frontal image depicts the front of the face of the patient with lips retracted to display at least one of maxillary or mandibular gingival lines.

7. The method of any one of claims 4 to 6, further comprising:
(a) using the at least one machine learning model to determine that at least one of the photo criteria for at least one of the images is unsatisfied;
(b) providing, via a graphical user interface, a graphical indication that the at least one of the images is failing to satisfy the photo criteria for the at least one of the images, wherein the graphical indication is displayed while the patient is taking the at least one of the images that fails to satisfy the photo criteria; and
(c) re-obtaining the at least one of the images that fails to satisfy the photo criteria.

8. The method of claim 7, wherein the photo criteria further comprises determining that at least one of a pitch, a yaw, or a roll of a head of the patient are within head orientation limits.

9. The method of any one of claims 1 to 8, further comprising 3D printing the prosthesis based on the output file.

10. The method of any one of claims 1 to 9, wherein the prosthesis is a maxillary prosthesis, the superior border of the prosthesis comprises a maxillary prosthetic plane, and the inferior border of the prosthesis comprises a maxillary occlusal plane.

11. The method of claim 10, wherein the facial landmarks comprise the ala and the tragus of the patient, and wherein determining the maxillary occlusal plane comprises:
(a) determining an ala-tragus line of the patient from the repose side profile image;
(b) transferring the ala-tragus line to the smiling side profile image; and
(c) shifting the ala-tragus line to the incisal edge of the patient, wherein the maxillary occlusal plane is co-planar with the ala-tragus line after the shifting.

12. The method of claim 10, wherein the labial border is determined as a plane from a most inferior portion of most labial gingival tissue of the patient to the proposed incisal edge of the patient.

13. The method of claim 10, wherein determining each of the buccal borders comprises:
(a) determining a maxillary prosthetic plane as a plane that is parallel to and superior to the maxillary occlusal plane; and
(b) determining the buccal border as a plane tangential to a buccal gingival tissue surface of the patient through the buccal height of contour of the tooth to the maxillary occlusal plane.

14. The method of claim 10, wherein determining the lingual border comprises:
(a) determining a maxillary prosthetic plane as a plane that is parallel and superior to the maxillary occlusal plane; and
(b) determining the lingual border as a surface extending from a height of contour of a lingual side of the maxillary teeth to the maxillary prosthetic plane.

15. The method of claim 10, wherein the distal borders respectively border endmost teeth of the prosthesis and determining each of the distal borders comprises:
(a) determining a maxillary prosthetic plane as a plane that is parallel and superior to the maxillary occlusal plane; and
(b) determining the distal border as a plane tangential to a distal height of contour surface of the endmost tooth to the maxillary prosthetic plane.

16. The method of claim 10, wherein determining the maxillary implant platform plane comprises:
(a) determining a maxillary prosthetic plane as a plane that is parallel and superior to the maxillary occlusal plane;
(b) determining a maxillary bone ridge line from a cone beam computed tomography image of the patient as a most inferior position of maxillary bone of the patient;
(c) determining a maxillary tissue line from an intraoral scan of the patient as a most inferior position of tissue along a maxillary arch of the patient;
(d) determining a maxillary calculated tissue thickness as a difference between the maxillary bone ridge line and the maxillary tissue line;
(e) determining heights of cylinders extending from the maxillary prosthetic plane; and
(f) determining the maxillary implant platform plane as a plane joining a superior aspect of the cylinders.

17. The method of claim 16, further comprising determining height and angulation of a multi-unit abutment that connects the maxillary prosthetic plane to a maxillary implant plane superior to the maxillary prosthetic plane, wherein the height and angulation are determined based on the heights of the cylinders and positions of the cylinders in the

18. The method of any one of claims 1 to 9, wherein the prosthesis is a mandibular prosthesis, the inferior border of the prosthesis comprises a mandibular prosthetic plane, and the superior border of the prosthesis comprises a mandibular occlusal plane.

19. The method of claim 18, wherein determining the mandibular occlusal plane comprises:
(a) determining an ala-tragus plane of the patient from the repose side profile image;
(b) determining the mandibular occlusal plane as a plane that is approximately 1 mm superior to a maxillary occlusal plane when maxillary and mandibular teeth are brought together.

20. The method of claim 18, wherein the labial border is determined as a plane from a most inferior portion of most labial gingival tissue of the patient through the tooth height of contour to the level of the proposed incisal edge of the patient.

21. The method of claim 18, wherein determining each of the buccal borders comprises:
(a) determining a mandibular prosthetic plane as a plane that is parallel to and inferior to the mandibular occlusal plane; and
(b) determining the buccal border as a plane tangential to a buccal gingival tissue surface of the patient going through the buccal height of contour and stopping at the mandibular prosthetic plane.

22. The method of claim 18, wherein determining the lingual border comprises:
(a) determining a mandibular prosthetic plane as a plane that is parallel to and inferior to the mandibular occlusal plane; and
(b) determining the lingual border as a surface extending from a lingual height of contour of the mandibular teeth to the maxillary prosthetic plane.

23. The method of claim 18, wherein the distal borders respectively border endmost teeth of the prosthesis and determining each of the distal borders comprises:
(a) determining a mandibular prosthetic plane as a plane that is parallel to and inferior to the mandibular occlusal plane; and
(b) determining the distal border as a plane tangential to a distal height of contour surface of the endmost tooth to the mandibular prosthetic plane.

24. The method of claim 18, wherein determining the mandibular implant platform plane comprises:
(a) determining a mandibular prosthetic plane as a plane that is parallel to and inferior to the mandibular occlusal plane;
(b) determining a mandibular bone ridge line from a cone beam computed tomography image of the patient as a most superior position of mandibular bone of the patient;
(c) determining a mandibular tissue line from an intraoral scan of the patient as a most superior position of tissue along a mandibular arch of the patient;
(d) determining a mandibular calculated tissue thickness as a difference between the mandibular bone ridge line and the mandibular tissue line;
(e) determining heights of cylinders extending from the mandibular prosthetic plane; and
(f) determining the mandibular implant platform plane as a plane joining an inferior aspect of the cylinders.

25. The method of any one of claims 1 to 24, wherein the at least one machine learning model determines the incisal edge of the patient based on one or more factors, wherein the one or more factors comprise factors selected from the group consisting of position of lips of the patient in repose, facial proportions of the patient, patient age, patient gender, and patient ethnicity.

26. The method of any one of claims 1 to 25, further comprising using the at least one machine learning model to select teeth for the prosthesis from a tooth library based on one or more factors, wherein the one or more factors comprise factors selected from the group consisting of inter-alar distance of the patient, facial width of the patient, width-to-height ratio of teeth, patient gender, and patient ethnicity.

27. The method of any one of claims 1 to 26, further comprising inserting a scannable bridge structure that is a silhouette of the prosthesis into a mouth of the patient, wherein the bridge structure is attached to a bone reduction guide or fixated to existing implants of the patient.

28. The method of claim 17 further comprising using the at least one trained machine learning model to digitally modify the prosthesis to accommodate temporary copings or modify the shape of the prosthesis to conform with the shape of the multi-unit abutment in correct relation to the tooth position and any other multi-unit abutments.

29. A system for collecting data for use in designing a personalized dental prosthesis for a patient, the system comprising:
(a) at least one camera;
(b) at least one processor communicatively coupled to the at least one camera; and
(c) at least one non-transitory computer readable medium communicatively coupled to the at least one processor, the at least one non-transitory computer readable medium having stored thereon computer program code that is executable by the at least one processor and that, when executed by the at least one processor, causes the at least one processor to perform the method of any one of claims 1 to 28.

30. At least one non-transitory computer readable medium having stored thereon computer program code that is executable by at least one processor and that, when executed by the at least one processor, causes the at least one processor to perform the method of any one of claims 1 to 28.
